(19) United States
(12) Patent Application Publication
(10) Pub. No.: US 2016/0155181 A1
(43) Pub. Date: Jun. 2, 2016

(54) SYSTEM AND METHOD OF DISPLAYING RELEVANT REAL ESTATE SERVICE PROVIDERS ON AN INTERACTIVE MAP

(71) Applicants: Walid Romaya, San Diego, CA (US); James Vaccaro, San Diego, CA (US)

(72) Inventors: Walid Romaya, San Diego, CA (US); James Vaccaro, San Diego, CA (US)

(21) Appl. No.: 14/593,805

(22) Filed: Jan. 9, 2015

Related U.S. Application Data
(60) Provisional application No. 61/925,330, filed on Jan. 9, 2014.

(51) Int. Cl. G06Q 30/06; G06Q 50/16; G06Q 30/02

(52) U.S. Cl. CPC G06Q 30/0627; G06Q 30/0641; G06Q 30/0282; G06Q 50/167

(57) ABSTRACT

A system and method of presenting real estate service providers within an interactive map by searching for listings and real estate service providers within a specified geographic area of interest. In response, retrieving listings and real estate service providers based within the specified geographic area of interest and having an overall high ranking score. The overall ranking score is based upon a quality score and a post score for each of the plurality of real estate service providers within the geographic area of interest. The posting score is determined by measuring user textual posting quality and the quality score determined by measuring user application usage. The post score and quality score may be configured based on application logic to dynamically update based on global user application usage and content of postings.

### RELATED APPLICATION(S)

This application claims the benefit of U.S. Provisional Patent Application No. 61/925,330, filed on Jan. 9, 2014, which is hereby incorporated by reference in its entirety.

### FIELD OF DISCLSOURE

The present application relates generally to generating a relevancy score for a real estate service providers and displaying real estate service providers with highest relevancy score within an interactive map containing real estate data.

### BACKGROUND

Homeowners and homebuyers have long needed an efficient way to discover and evaluate information about real estate service providers. The typical person finds information about real estate service providers by word of mouth, by checking the classified advertisements section of the newspaper, or perhaps by submitting a text query to an internet search engine, such as Google. None of those methods are completely satisfactory solutions to the problem of finding and selecting a real estate service provider.

Real estate agents are one type of real estate service provider. Real estate agents assist buyers and sellers with the complex process of buying a home. Real estate agents provide property information, sales forms, and generally guide the buyer and seller through the purchasing process. Examples of other real estate service providers are mortgage brokers, mortgage officers, banks, property inspectors, appraisers, property cleaning companies, and moving companies.

There is a need for a system that overcomes limitations of the current real estate system, as well as providing additional benefits.

### SUMMARY

In one innovative concept, displaying the zone list of real estate professionals for a postal code, a computer scores posts by real estate professionals directed to the postal code on a real estate website. In addition, the computer displays on the real estate website a zone list of real estate professionals for the postal code. The real estate professionals are sorted based on the post scores for the postal code.

In another innovative concept, a system and method of presenting real estate service providers within an interactive map by searching for listings and real estate service providers within a specified geographic area of interest. In response, retrieving and displaying onto an interactive map to a user, listings and real estate service providers based within the specified geographic area of interest and having an overall high ranking score. The overall ranking score is based upon a quality score and a post score for each of the plurality of real estate service providers within the geographic area of interest. The posting score is determined by measuring user textual posting quality and the quality score determined by measuring user application usage. Moreover, generating a revised ranking score of each of the plurality of real estate service providers based upon interpretation of a plurality of user search requests, post requests, or application usage of a plurality of users.

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description,” one will understand how the features of the various embodiments of this invention provide advantages that include improved communications between users system and merchants of the system.

In the following description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of disclosure.

FIG. 1A is a schematic block diagram illustrating one embodiment of a real estate search and listing system;

FIG. 1B is a schematic block diagram illustrating one alternate embodiment of a real estate search and listing system;

FIG. 1C is a schematic block diagram illustrating one alternate embodiment of a real estate search and listing system;

FIG. 2A is a schematic block diagram illustrating one embodiment of a real estate professional entry;

FIG. 2B is a schematic block diagram illustrating one embodiment of a post entry;

FIG. 2C is a schematic block diagram illustrating one embodiment of site data;

FIG. 3 is a schematic flow chart diagram illustrating one embodiment of a zone list display method; and

FIG. 4 is a schematic block diagram illustrating one embodiment of a computer.

FIG. 5A is a system architecture diagram of an exemplary real estate search system in accordance with one embodiment.

FIG. 5B is an exemplary message diagram for updating a relevancy score in accordance with one embodiment.

FIG. 5C is an exemplary message diagram for generating an interactive map comprising listing data and real estate service providers in accordance with one embodiment.

FIG. 6 is a functional block diagram of an exemplary wireless real estate search system in accordance with one embodiment.

FIG. 7A is a flowchart for an exemplary method for adjusting user ranking score in accordance with one embodiment.

FIG. 7B is a flowchart for an exemplary method of updating a user post score in accordance with one embodiment.

FIG. 7C is a flowchart for an exemplary method of updating a user's quality score in accordance with one embodiment.

FIG. 7D is a flowchart for an exemplary method of updating a user's quality score in accordance with one embodiment.

FIG. 8A is an illustrative user profile graphical user interface for the present disclosure.

FIG. 8B is an illustrative user profile graphical user interface for the present disclosure.

FIG. 8C is an illustrative user profile graphical user interface for the present disclosure.

FIG. 9 is an exemplary user interface for the post module for the present disclosure.

FIG. 10A is an illustrative real estate service provider search and result interface for the present disclosure.

FIG. 10B is an illustrative real estate property search and result interface for the present disclosure.

FIG. 10C is an illustrative real estate property search and result interface for the present disclosure.

FIG. 11 is an exemplary user interface for the chat module for the present disclosure.

FIG. 12 is an exemplary user interface for the newsfeed module for the present disclosure.

### DETAILED DESCRIPTION

One non-limiting advantage of the described systems and methods is ability to identify relevant real estate service providers (such as, real estate agents, brokers, mortgage officers, etc) along with real estate listing within an interactive map. For example, a user may provide the system with a search criteria specifically identifying the physical characteristics of a property for which the user is interesting in purchase or lease (i.e. 4 bedrooms, 2 bath, etc.), and the geographic area of interest (i.e. San Diego, Calif.) will be presented with an interactive map which will display both real estate listed for sale which meets the users search criteria and further includes names, photos, contact information, ratings, reviews, etc. of highly qualified real estate service providers (such as, real estate agents, real estate mortgage officers, appraisers, house cleaning, etc.).

Another non-limiting advantage of the described system and method is the ability to filter relevant real estate service providers within a geographic area of interest based upon the real estate service provider's area of expertise.

In yet another non-limiting advantage of the describe system and method is the ability to identify relevant real estate service providers along with real estate listings within a list-view format. For example, a user may provide the system with a search criteria specifically identifying the physical characteristics of a property for which the user is interesting in purchase or lease (i.e. # bedrooms, # baths, etc.), and the geographic area of interest (i.e. Detroit, Mich.) will be presented with a list-view display which will display both real estate listed for sale which meets the users search criteria and further includes names, photos, contact information, ratings, reviews, etc. of highly qualified real estate service providers (such as, real estate agents, real estate mortgage officers, appraisers, house cleaning, etc.). The user is then able to filter the real estate service providers by area of expertise and sort based upon: alphabetical order, proximity to user, proximity to listing of interest, proximity to geographic area of interest, ranking score, and other available means of sorting.

In yet another non-limiting advantage of the describe system and method is the ability to measure the quality of a user posting textual string message. For example, a user may be permitted to post a textual string message which may include other interactive media (such as, video, audio, images, etc) and meta-data tagged to the posting (such as, geographic area information, geo-location, events, listings, etc.) which is analyzed against a dynamic dictionary which adapts to user's posting behavior (i.e. words being used) and dynamically revises its assigned scoring schema in response to knowledge gained from the plurality of user posting items being generated by all user of the system.

In yet another non-limiting advantage of the describe system and method is the ability to measure the user's feature adoption rate of the system. For example, a user may be permitted to perform certain actions within the system, such as, chatting, posting, completing his user profile, responding to user messages, etc., which are analyzed against a dynamic quality metrics which adapts to user's usage behavior and dynamically revises its assigned scoring schema in response to knowledge gained from the application usage of all user of the system.

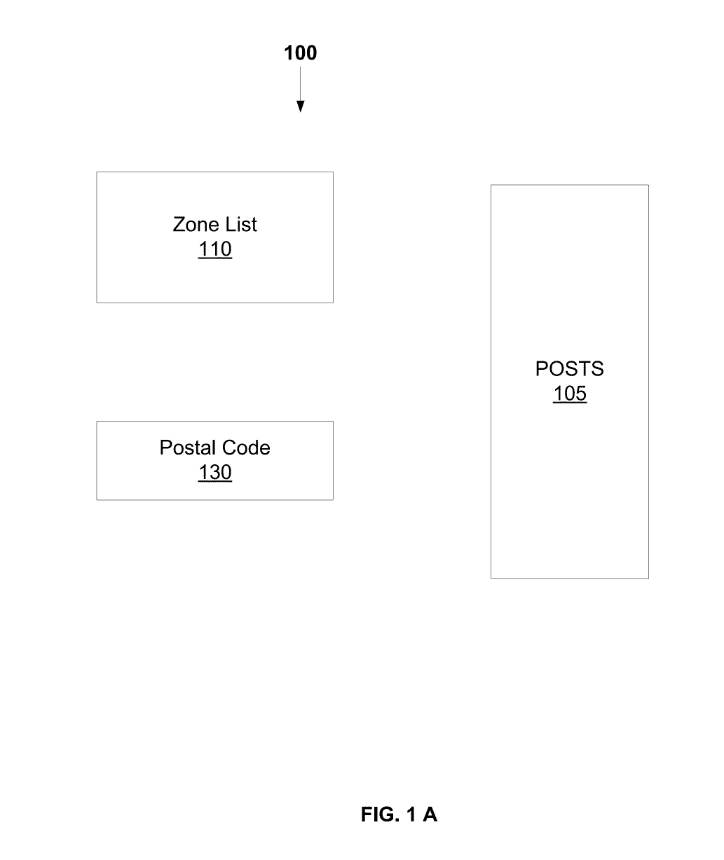

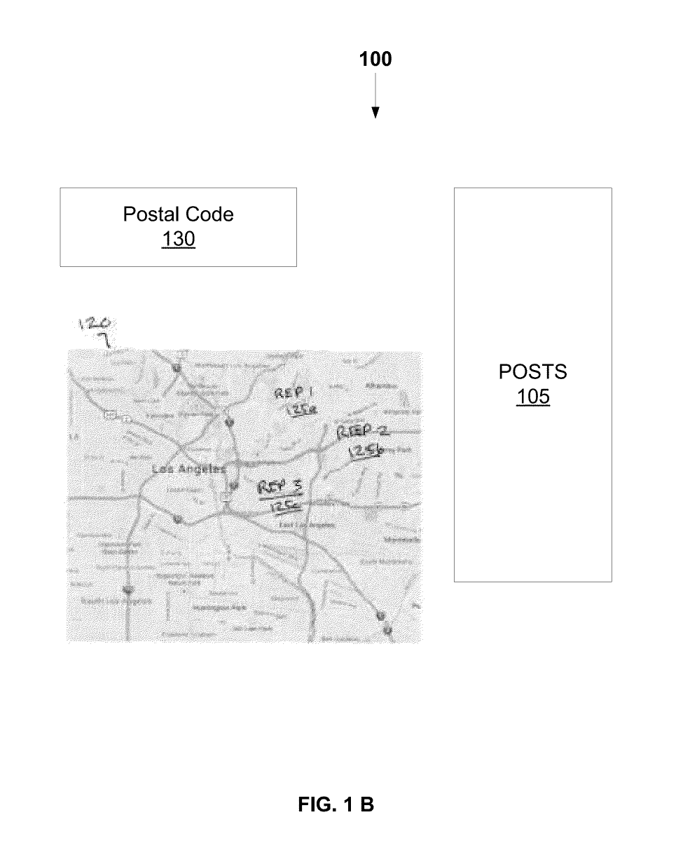

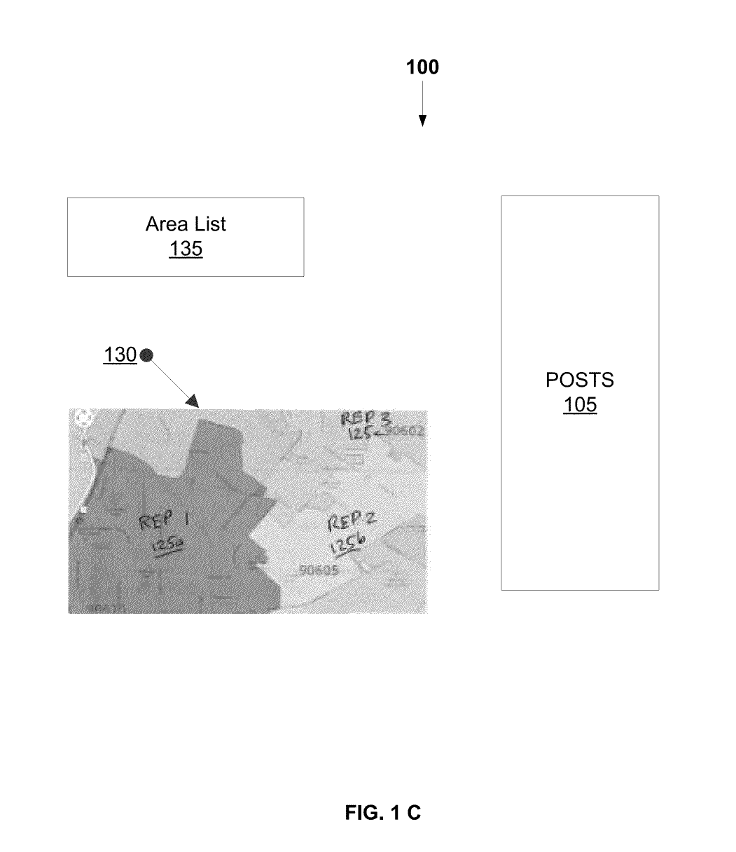

Example implementations of the system and method discussed above are described below in further detail in connection with FIGS. 1-12.

FIG. 1A is a schematic block diagram illustrating one embodiment of a real estate search and listing system 100. In the depicted embodiment, the real estate website 100 includes posts 105 and a zone list 110. The real estate website 100 may include other information that for simplicity is not depicted. The posts 105 may be text content, audio content, video content, image content, or combinations thereof. In one embodiment, the posts 105 provide timely information about the real estate market and/or trends relating to the real estate market.

In the past, real estate websites have provided listings and/or referrals for real estate professionals. Inclusion in these listings and/or referrals are often purchased by the real estate professionals. As a result, inclusion in a listing or referral is often unrelated to the real estate professional's knowledge of a particular area. The embodiments described herein display a zone list 110 of real estate professionals that is sorted based on post scores for a specified postal code. As a result, inclusion and/or ranking in the zone list 110 is based on the real estate professional's knowledge of the postal code area as will be described hereafter.

The posts 105 may be made by real estate professionals. A real estate professional may be one of a real estate agent, a mortgage broker, a mortage banker, an insurance agent, a title representative, and/or an escrow representative. The real estate professionals may satisfy a membership policy as will be described hereafter. A portion of the posts 105 may be from sponsored real estate professionals.

Alternatively, users of the real estate website 100 such as buyers and/or sellers may also submit posts 105 to the website 100. In one embodiment, the users do not satisfy the membership policy. Posts 105 that are submitted by users may be displayed. In one embodiment, posts 105 that are submitted by users are marked with one or more of highlighting, the specified color, a specified shading, and/or specified icon.

In one embodiment, posts 105 by real estate professionals and directed to a postal code are scored. The zone list 110 is displayed for a specified postal code 130. In one embodiment, the postal code 130 is a ZIP Code. A user may enter the postal code 130. Alternatively, the user may enter an address and the website 100 may generate the postal code 130. In one embodiment, the user may select an area of the map and the website 100 may generate the postal code 130. The real estate professionals in the zone list 110 may be sorted based on the post scores for the postal code 130.

FIG. 1B is a schematic block diagram illustrating one alternate embodiment of the real estate search and listing system 100. In the depicted embodiment, the website 100 includes a map 120. The map 120 is displayed with a graphical representation 125 of each real estate professional in the zone list 110 overlaying an area of the postal code 130. In one embodiment, each graphical representation 125 includes one or more of a name, an image, a telephone number, and a hyperlink. The hyperlink mailing to a profile for the real estate professional.

In one embodiment, the map 120 comprises a street heat map. The street heat map may be a layer over the map 120 where the individual streets within the map 120 are color coded to reflect median values for homes in the specific street and the average value per square foot for the homes in the specific street. The colors for each street may change depending on the median values for homes in the specific street and the average value per square foot for the homes in the specific street. An algorithm of the median values for homes in the specific street and the average value per square foot for the homes in the specific street is calculated based on a combination that include historical sales prices, assessor's tax records, number of homes in street and geographic location of homes within street. The specific colors are indicated on a scale whereby the lower values reflect first colors such as blue colors and the higher values are second colors such as red colors with a combination of colors and hues in between.

In one embodiment, as a mouse cursor is hovered over the colored street a small panel will show the median value for the street and the average per sq foot for the street. The values within the panel change depending on the position of the cursor within the street.

FIG. 1C is a schematic block diagram illustrating one alternate embodiment of the real estate search and listing system 100. In the depicted embodiment, the website 100 displays an area list 135 of real estate professionals for a coverage area. The coverage area may be one or more of a neighborhood, a metropolitan area, a political unit, and a geographic area. In one embodiment, the area list 135 comprises real estate professionals with highest post scores for each postal code within the coverage area.

In the depicted embodiment, a coverage map 130 is displayed. In one embodiment, a graphical representation 125 of each real estate professional in the area list 135 overlays the coverage area on the coverage map 130.

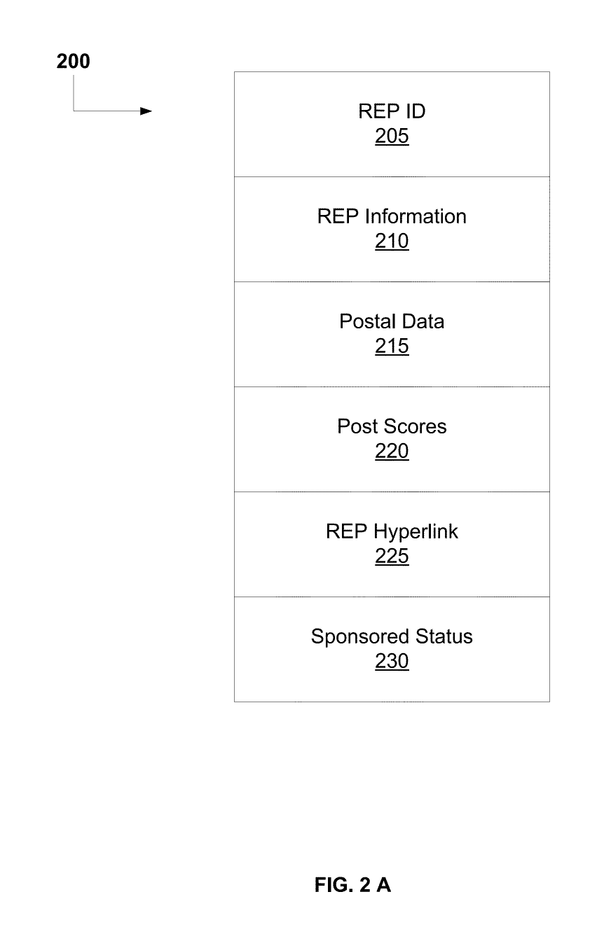

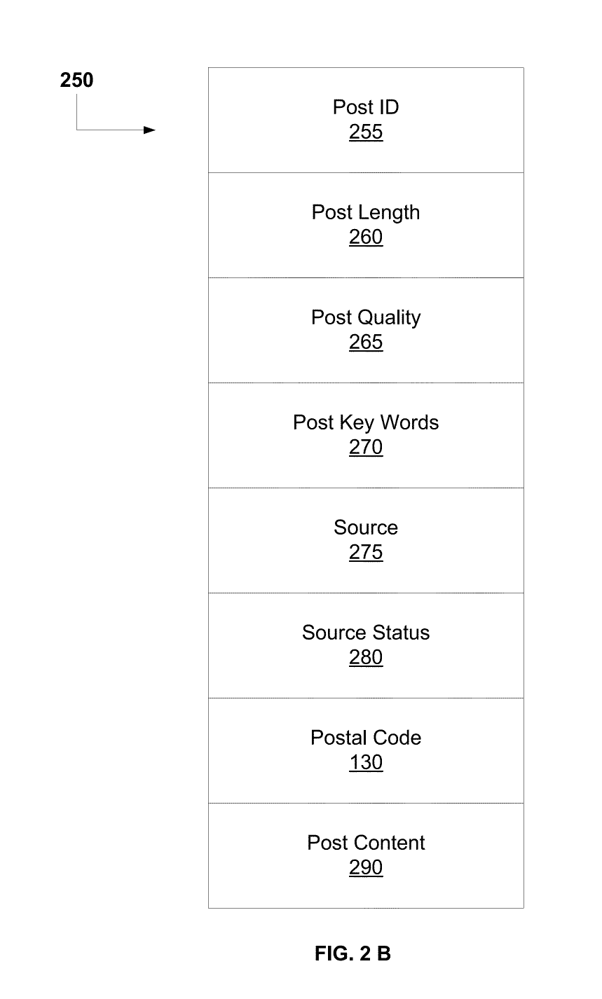

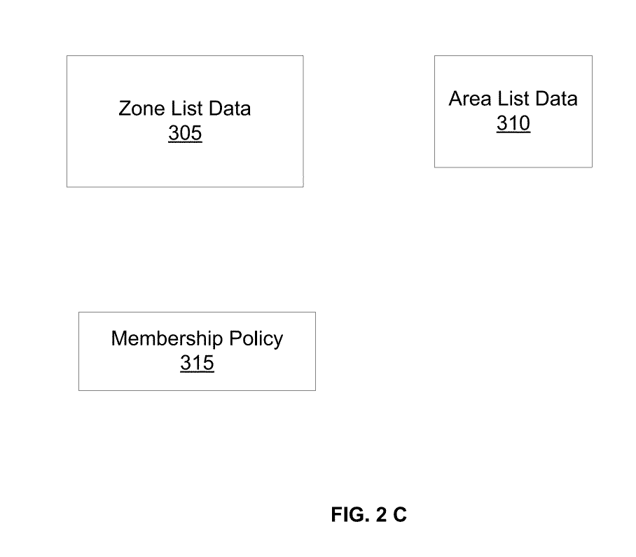

FIG. 2A is a schematic block diagram illustrating one embodiment of a real estate professional entry 200. The entry 200 may be stored in a real estate professional database. An entry 200 may be created in the real estate professional database for each real estate professional that is registered with the real estate website 100. In the depicted embodiment, the entry 200 includes a real estate professional identifier 205, real estate professional information 210, post data 215, post scores 220, a real estate professional hyperlink 225, and a sponsored status 230.

The real estate professional identifier 205 may uniquely identify the real estate professional. In one embodiment, the real estate identifier 205 is an index for the real estate professional database. The real estate professional information 210 may include contact information, a biography, an image, an audio message, a video message, professional certifications, professional honors, testimonials, and the like for the real estate professional.

The post data 215 may include data on posts 105 made by the real estate professional. In one embodiment, the post data 215 may summarize data from the post entry that will be described hereafter. For example, the post data 215 may summarize the postal codes, post links, post quality, and post keywords of posts 105 made by the real estate professional.

The post scores 220 may be calculated from the posts 105 of the real estate professional as will be described hereafter. In one embodiment, a post score 220 is calculated for each postal code for which the real estate professional submits posts 105.

The real estate professional hyperlink 225 may link to a website, a profile page, or the like for the real estate professional. The sponsored status 230 may indicate whether the real estate professional makes sponsored posts and/or is included in the zone list 110 as a sponsored real estate professional. In one embodiment, the sponsored status 230 specifies a frequency of displaying the sponsored real estate professional in the zone list 110.

FIG. 2B is a schematic block diagram illustrating one embodiment of a post entry 250. The post entry 250 may be stored in a post database. Each post 105 to the real estate website 100 may have a post entry 250. In the depicted embodiment, the post entry 250 includes a post identifier 255, a post length 260, a post quality 265, post keywords 270, a source 275, a source status 280, a postal code 130, and post content 290.

The post identifier 255 may uniquely identify the post 105. The post identifier 255 may be an index to the post database. The post length 260 may be a length of the post 105. The post length 260 may be a word count, an audio message length, a video message length, a number of images, or the like.

The post quality 265 may include information on a number of users that have found the post 105 to be helpful. For example, if a user indicates that the post 105 was helpful, the indication may be stored in the post quality 265. In addition, the post quality 265 may include a score for significant words and/or phrases, blatantly commercial language, spam, and the like.

The post keywords 270 may include keywords for the post 105. The post keywords 270 may be submitted with the post 105. Alternatively, the post keywords 270 may be parsed from the post 105.

The source 275 may specify the source of the post 105. If the post 105 is submitted by real estate professional, the source 275 may be the real estate professional identifier 205. If the post 105 is submitted by a user, the source 275 may be a user email, a user identifier, or the like.

The source status 280 may indicate whether the source 275 is a real estate professional, a sponsored real estate professional, and/or a user. The postal code 130 is the postal code associated with the post 205. The postal code 130 is received with the post 105 submission.

The post content 290 may be a text message, an audio message, one or more images, a video message, or combinations thereof. The post content 290 may be submitted by a real estate professional, a sponsored real estate professional, and/or a user.

FIG. 2C is a schematic block diagram illustrating one embodiment of site data. The data includes zone list data 305, area list data 310, and the membership policy 315. The data may be stored in a database, a linked data structure, a flat file, and initialization file, or combinations thereof. The data may be stored in a memory.

In one embodiment, the membership policy 315 specifies one or more of credentials, membership fees, registration information, postal codes 130, and the like that are required of a real estate professional to submit posts 105 to the website 100 as a real estate professional.

In one embodiment, only real estate professionals that satisfy the membership policy 315 may submit posts 105 as real estate professionals.

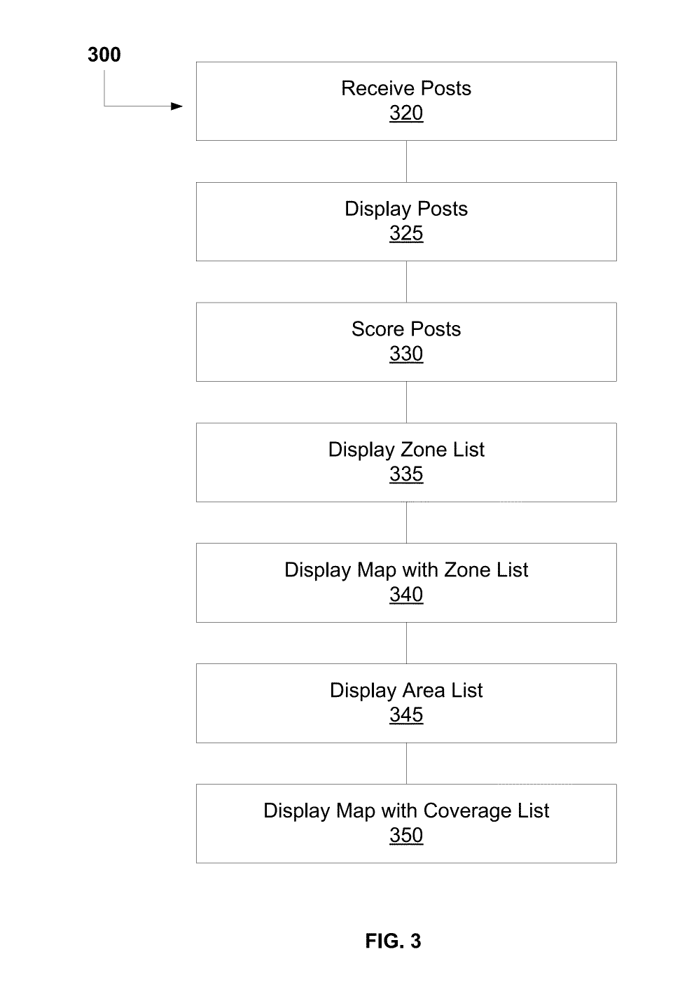

FIG. 3 is a schematic flow chart diagram illustrating one embodiment of a zone list display method 300. The method 300 may perform the functions of the real estate website 100. In one embodiment, the method 300 is performed by use of a processor. Alternatively, the method 300 may be embodied in a computer program product. The computer program product may include a memory such as a computer readable storage medium that stores program code. The program code may be executed by the processor to perform the functions of the method 300. The processor and memory may be embodied in a computer.

The method 300 starts, and in one embodiment, a computer receives 320 posts 105 for the real estate website 100. The posts 105 may be from real estate professionals, sponsored real estate professionals, and/or users. The post 105 may be received 320 through a browser interface. Each post may be stored as a post entry 250. Each post 105 may include content such as text, images, audio content, video content, or combinations thereof. In addition, each post 105 may be directed to a postal code 130.

The computer may display 325 the posts 105 on the real estate website 100. Posts 105 for a specified postal code 130 may be displayed 325. The specified postal code 130 may be selected by a user. In one embodiment, the displayed posts 105 comprise sponsored posts 105 from a sponsored real estate professional. The sponsored posts 105 may be included within a specified sponsored post time interval. In one embodiment, the sponsored posts 105 are displayed with the post 105 based on a post algorithm. The post algorithm may display the sponsored post after a post number of non-sponsored posts 105. The post number may be in the range of 3 to 10 posts. For example, if the post number is five posts, the post algorithm may display the sponsored post 105 after every five non-sponsored posts 105. User posts may also be displayed 325.

In one embodiment, the computer scores 330 the posts 105 by the real estate professionals directed to the postal code 130. The computer scores 330 the posts 105 for a real estate professional by calculating a post score 220 for the real estate professional. The computer may calculate a post score 220 for one or more postal codes 130 for the real estate professional.

In one embodiment, the post scores 220 are calculated as a function of a temporally weighted average of post instances 105 by each real estate professional. For example, a post score PS 220 may be calculated using Equation 1, where t is a time interval from the post instance 105, where n! is the product (1×2× . . . ×n) and where e is the mathematical constant e=Σ1/(n!) and approximately equal to 2. 1828.

PS=Σ1/log(t+e) Equation 1

In an alternative embodiment, the post scores 220 are calculated as a function of post length 260. For example, the post score PS 220 may be calculated using Equation 2, where PL is the post length 260 of each post 105.

PS=ΣPL Equation 2

In one embodiment, the post scores 220 are calculated as a function of post quality 265. For example, the post score PS 220 may be calculated using Equation 3, where PQ is the post quality 265 of each post 105.

PS=ΣPQ Equation 3

In a certain embodiment, the post scores 220 are calculated as a function of post keywords 270. For example, the post score PS 220 may be calculated using Equation 4, where PK a keyword score for the post keywords 270 of the post 105. The keyword score may be calculated by assigning each keyword of the post keywords 270 a value from a keyword list.

PS=ΣPK Equation 4

The post scores 220 may be calculated as a function of temporal weight, post length 260, post quality 265, and post keywords 270. For example, the post scores PS 220 may be calculated using Equation 5, where K1, K2, and K3 or nonzero constants.

PS=Σ((K1*PL)+(K2*PQ)+(K3*PK))/(log(t+e)) Equation 5

The computer may display 335 the zone list 110. The zone list 110 may comprise a specified number of real estate professionals with highest post scores 220. In one embodiment, the zone list 110 is for a specified postal code 130. The zone list 110 may comprise a specified list number of real estate professionals with the highest post scores 220 for the postal code 130. The specified list number may be in the range of 3 to 5 real estate professionals.

In one embodiment, the zone list 110 comprises sponsored real estate professionals. The sponsored real estate professionals may pay a fee for inclusion in the zone list 110. The sponsored real estate professionals may be displayed 335 in the zone list 110 based on a display algorithm. In one embodiment, the display algorithm displays the sponsored real estate professional in between 10 to 90 percent of zone lists 110.

In an alternative embodiment, the display algorithm displays 335 sponsored real estate professionals in the zone list 110 when a lowest post score 220 for real estate professional in the zone list 110 is less than a sponsor threshold. In one embodiment, the display algorithm displays 335 sponsored real estate professionals as a function of the post score 220 for the sponsored real estate professional.

In one embodiment, the computer displays 340 the map 120 with the graphical representation 125 of each real estate professional in the zone list 110 overlaying an area of the postal code 130.

The computer may display 345 the area list 135 on the real estate website 100. The area list 135 may include real estate professionals for the coverage area. The area list 135 may comprise the real estate professionals with the highest post scores 224 each postal code 130 within the coverage area.

In one embodiment, the computer displays 350 the coverage map 130 with a graphical representation 125 of each real estate professional in the area list 135 overlaying the coverage area and the method 300 ends.

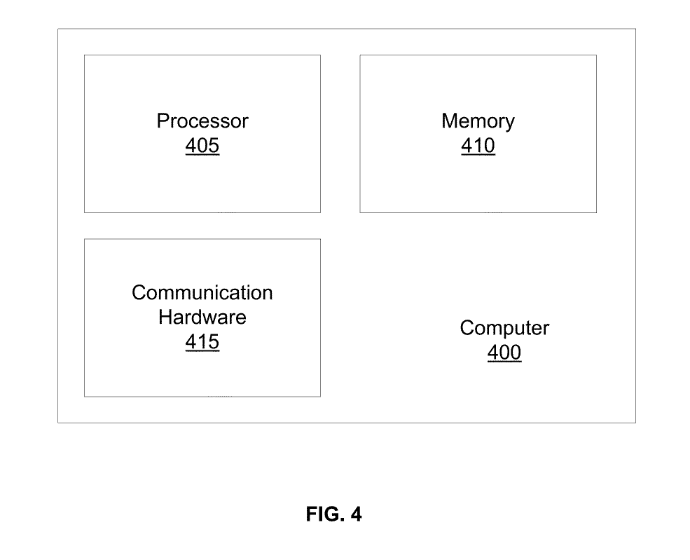

FIG. 4 is a schematic block diagram illustrating one embodiment of a computer 400. The computer 400 includes a processor 405, a memory 410, and communication hardware 415. The memory 410 may be a computer readable storage medium such as a semiconductor storage device, a hard disk drive, a holographic storage device, a micromechanical storage device, or the like. The memory 410 may store program code. The processor 405 may execute the program code. The communication hardware 415 may communicate with other devices.

By displaying the area list 135 with the real estate professional sorted based on the post scores 224 a postal code 130, the area list 135 includes real estate professionals that are more knowledgeable about the market within the postal code 130 as indicated by the number and quality of the posts 105 by those real estate professionals. As a result, the area list 135 provides a more useful referral of real estate professionals.

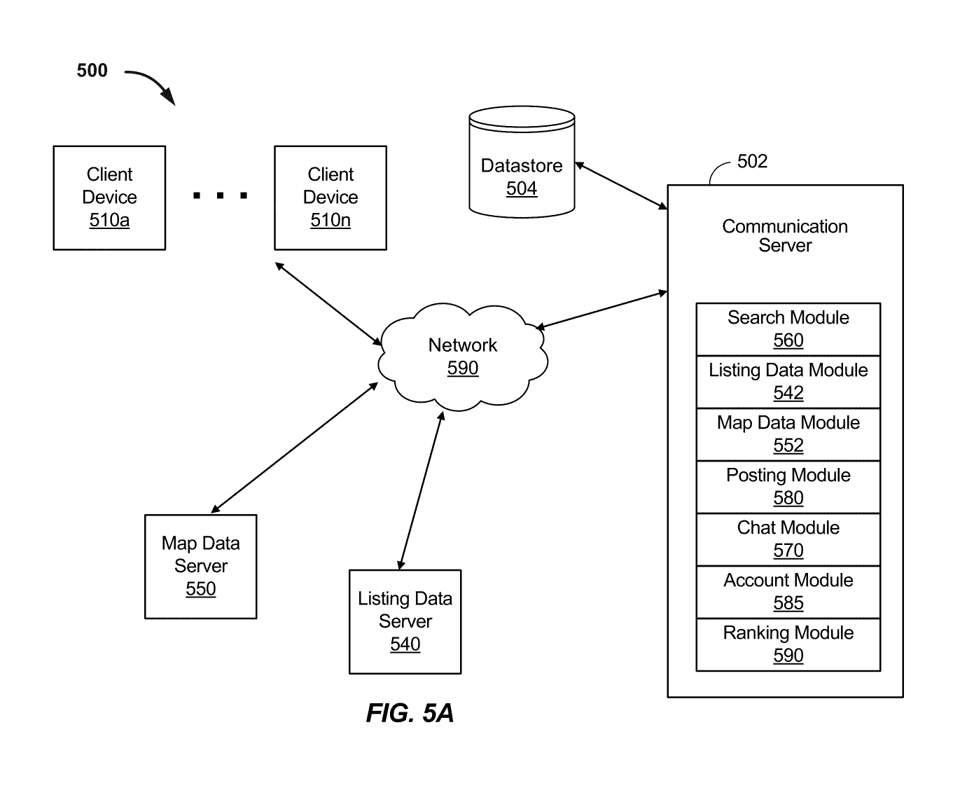

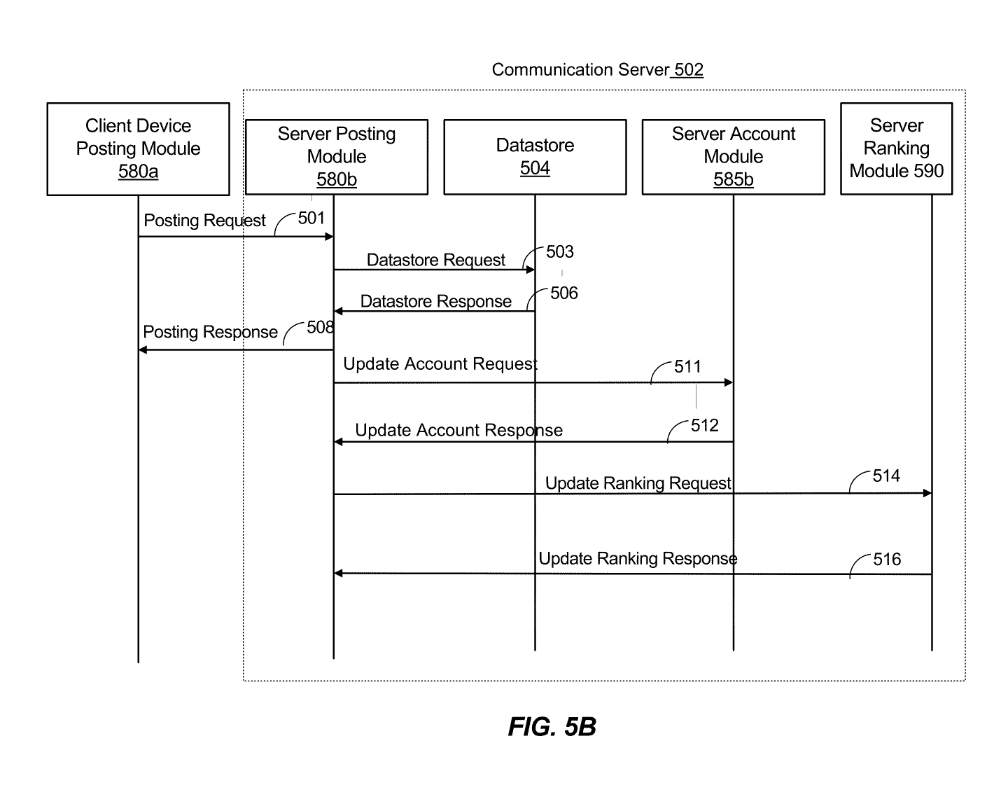

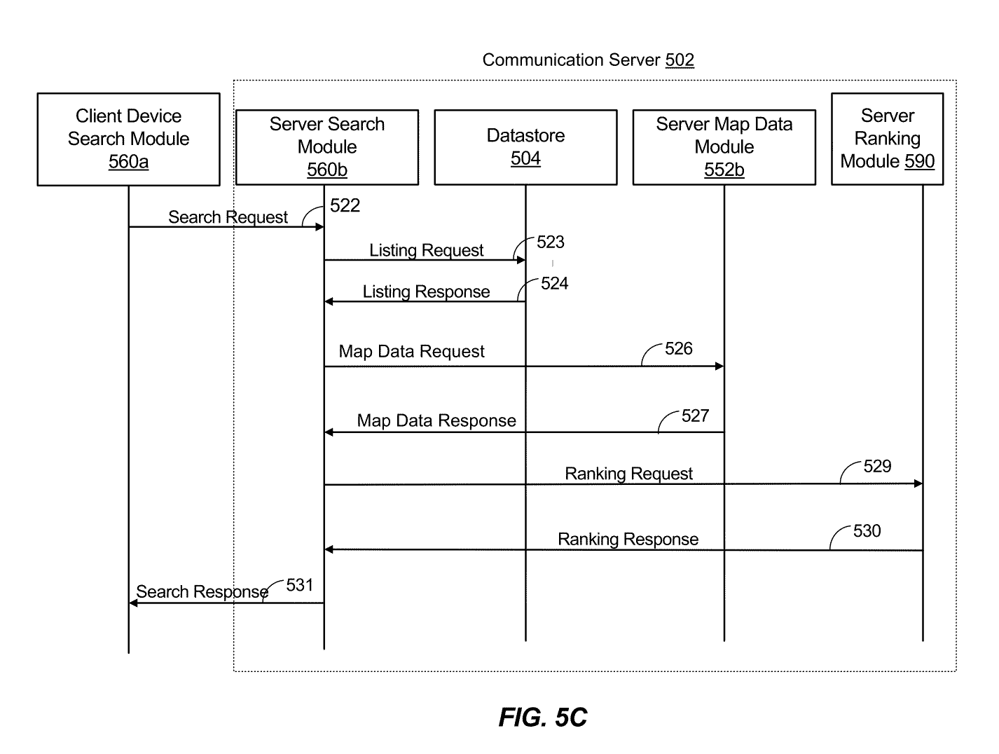

FIG. 5A is a functional block diagram of an exemplary real estate search system in accordance with one embodiment. The system 500 may be implemented via a client-server architecture where a client device 510a-510n has an application running locally that performs a set of functions that require communication with a communication server 502 in order to support desired functionality. The client application may be configured to allow users to input their desired request of the application via the client device 510a-510n, after which the request is sent to the communication server 502 for processing. The communication server 502 may be configured to optionally archive some information, and the request may be routed either back to the initiating user and/or to a target user device. The system 500 shown includes multiple client devices (e.g., a client device 510a and a client device 510n). It will be appreciated that fewer or more client devices may be included in the system 500. The client device 510a and the client device 510n (collectively or individually hereinafter referred to as “client device 510”) may be an electronic communication device configured to transmit and receive conversation items in a threaded conversation. Examples of such electronic communication devices include smartphones, feature phones, laptop computers, desktop computers, tablet computers, personal digital assistants, set-top devices, gaming consoles, automotive dashboard systems, kiosks, self-service consoles, and the like.

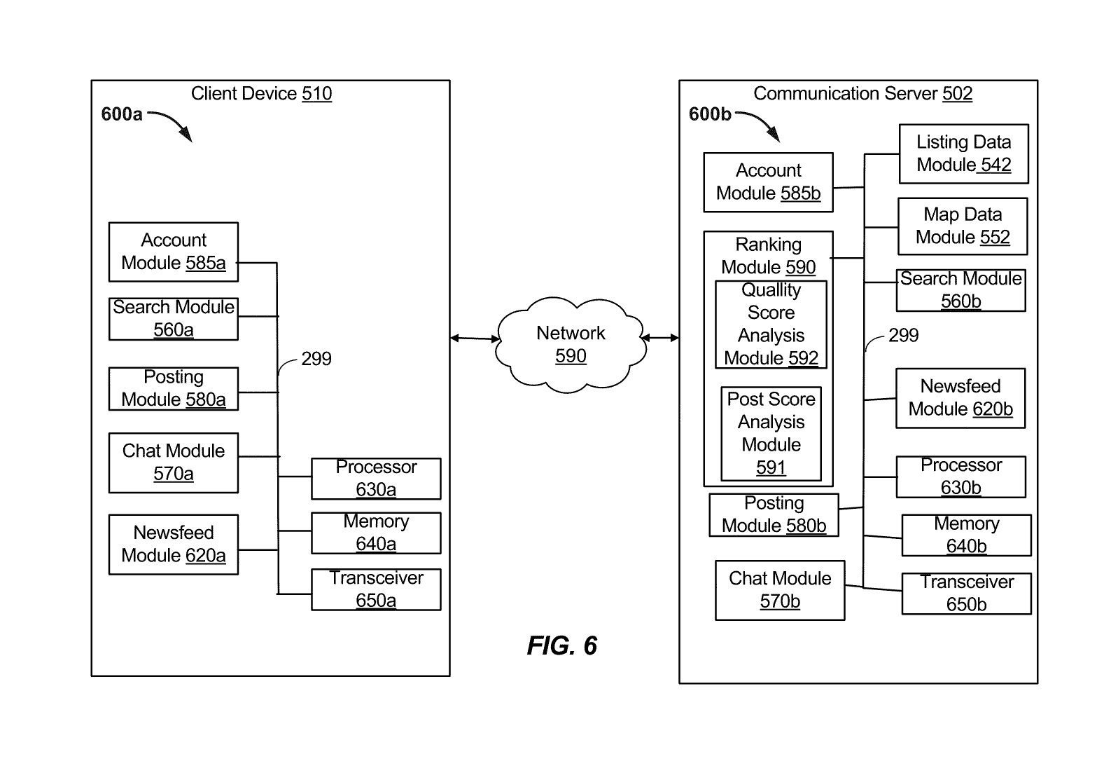

The client application residing within the client device 510 may be configured to transmit and receive account management requests, search requests, posting items requests, newsfeed requests, and chat requests described herein. The client device 510 may include specialized circuitry configured to transmit, receive, generate, and process the messages discussed in further detail below. In some implementations, the client device 510 may include a processor which is configured to execute stored instructions which cause the client device 510 to transmit, receive, generate, and process the messages described. The client device 510 may include additional modules as described in connection with FIGS. 5B, 5C, and 6 below.

The system 500 may be configured to transmit and receive messages via the network 590. Examples of the network 590 include a wide area network (WAN), metropolitan area network (MAN), local area network (LAN), wireless local area network (WLAN), or personal area network (PAN). Although shown as one network, the network 590 may include several interconnected networks. The networks which may be included in the system 500 may differ according to the switching and/or routing technique used to interconnect the various network nodes and devices (e.g., circuit switching vs. packet switching), the type of physical media employed for transmission (e.g., wired vs. wireless), and the communication protocols used (e.g., Internet protocol suite, SONET (Synchronous Optical Networking), Ethernet, etc.). Regardless of the form the network 590 may take, the network 590 is configured to facilitate machine-to-machine messaging for tagging and communication as described herein.

The client device 510 may transmit and receive account management request and response messages. The account management requests may be processed by a communication server 502, more specifically, the account module 585. The communication server 502 is configured as a hub to account management information activities within the system 500. The communication server 502 may be configured to process the received account management requests by verifying the associated account, validating the user account information, storing the user account data in a datastore 504, and providing user account information to other modules within the communication server 502 which are reliant on user account information in order to function properly.

The communication server 502 may be configured to respond to user search requests for real estate properties, real estate professionals, or both . The searching may be based on meta-data stored in the datastore 504 as being associated to user accounts, listing data, or map data. The communication server 502 may be configured to respond to user search request for real estate properties by generating an interactive map of properties within a specified geographic area. Alternatively, the communication server 502 may be configured to respond to user search requests for real estate professionals, wherein the user is seeking to only search for real estate service providers within a geographic area. The communication server 502 may be configured to respond to user search request for real estate professionals by providing either an interactive map identifying real estate service providers or by providing a list view of real estate service providers within a specified geographic area. In another embodiment, the communication server (by means of search module 560), may be configured to provide an interactive map, or optionally a list view, of real estate properties and real estate service providers within a user specified geographic area provided within a search request.

The communication server 502, by means of the listing data module 542, may request data from the listing data server 540 and the listing data server 540 may in response transmit listing data (i.e. MLS data, rental data, trial occupancy data, option lease data) into the communication server 502. In some implementations, it may be desirable to have the listing data server 540 automatically configured to communicate directly with the communication server 502 based upon a rule/condition that is satisfied. The listing data server 540 may be configured to maintain up to date information regarding property-listing information, such as a multiple listing service (MLS) repository. In another embodiment, the listing data module 542 may be configured to permit users to add property listings (for sale, for rent, for trial occupancy, for option lease contracts), which are searchable by other users.

The communication server 502, by means of the map data module 552, may request data from the map data server 550 and the map data server 550 may in response transmit map data into the communication server 502. In some implementations, it may be desirable to have the map data server 550 automatically configured to communicate directly with the communication server 502 based upon a rule/condition that is satisfied. The map data server 550 may be configured to maintain up to data information regarding map information, such as Google maps available via application program interface (API) call.

Each of the identified external data sources to the communication server 502 (in example, map data server 550 and listing data server 540, or others external data source) have a corresponding module within the communication server (in example, map data module 552, listing data module 542, or other internal data sources) in order to execute program instructions to generate an interactive map which displays either or both real estate properties and a select number of relevant (or highly ranked) real estate service providers within a specified geographic area.

The communication server 502 may include additional modules as described in connection with FIG. 6 as described below.

FIG. 5B is an exemplary message diagram for updating a relevancy score by initiating a post request in accordance with one embodiment. The message flow of FIG. 5B shows messages exchanged between several entities, which can be included in a real estate search and listing system. For ease of explanation, the number of entities shown has been limited. However, it will be understood that additional entities can be added or multiple entities combined consistent with the description herein.

Messaging 501 may be performed in allowing a user of a client device to submit a post request. In one embodiment, a user of a client device executing application code and utilizing the client device posting module 580a to transmit a posting item from the client device 510 to the communication server 52, wherein the posting item may include images files, audio files, video files, or other media type; tagged (or identified) zip codes or neighborhoods to be associated with the posting item; and text-based description. The client device posting module 580a transmits a post request 501 to the communication server 502 where it's handled in the server posting module 580b, which accepts the request and handles further processing of the request.

Messaging 503 may be performed by requiring the server posting module 580b to transmit a datastore request 503 to the datastore 504. In one embodiment, a the server posting module 580b will automatically transmit the posting item received from the client device posting module 580a to the datastore 504 in order to store it.

Messaging 506 may be performed by requiring the datastore 504 to transmit a datastore response 506 to the server posting module 580b to confirm receipt of the datastore request 503. In one embodiment, the datastore 504 may transmit a confirmation response message to the posting server module 580 to confirm successful storage of posting item received.

Message 508 may be performed by requiring the server posting module 580b to transmit a posting response (confirmation of successful post transmission) to the client device posting module 580a. In one embodiment, the client device receives a confirmation response message that the posting item has been successful handled by the communication server 502. In another embodiment of the disclosure, the posting response message 508 may not be required, and thus, omitted as an intermediary process within the posting message diagram as shown in FIG. 5B.

Message 511 may be performed by transmitting an update account request from the server posting module 580b to the server account module 585b. In one embodiment, the account module 585b is responsible for updating the user profile for a user, which contains links to posting items of the user. Thus, the posting module 580b may notify the account module 585b that a new posting item has been received and should be associated to the user's profile.

Message 512 may be performed by transmitting an update account response from the server account module 585b to the server posting module 580b to confirm receipt of the update account request 511. In one embodiment, the server posting module 580b may require confirmation that the server account module 585b has successful received notification that a new posting item has been initiated by the user.

Message 514 may be performed by transmitting an update-ranking request 514 from the server posting module 580b to the server-ranking module 590. In one embodiment, the posting module 580b notifies the ranking module 590 that a new posting item has been initiated by the user, which should be factored into the ranking calculations. In another embodiment, the server account module 585b after receiving the account request may transmit an update ranking request, on behalf of the posting module 580b, in order to notify the ranking module 590 that a new posting item has been initiated by the user. The ranking module 590 will analyze the update ranking request, which contains notification that a new posting item was completed by the user by executing program code to update the calculations for the user's post score by means of the post score analysis module 591 and the user's quality score by means of the quality score analysis module 592 in order to generate an updated relevancy ranking score for the user.

Message 516 may be performed by transmitting an update ranking response from the server-ranking module 590 to the server posting module 580b to confirm receipt of the update-ranking request 514. In one embodiment, the server ranking module 590 may automatically transmit a confirmation update ranking response message 516 to the server posting module 580b in order to confirm successful receipt of the updating ranking request message 514. In another embodiment, the server ranking module 590 may automatically transmit a confirmation update ranking response message to the account module 585b in order to confirm successful receipt of the updating ranking request message, if initiated by the server account module 585b.

In addition, the server posting module 580b may transmit an update newsfeed request message (not shown) to the server newsfeed module 620b in order to transmit the contents of the posting item to the newsfeed module 620b to be displayed to other users utilizing the application. Optionally, the newsfeed module 620b may transmit an update newsfeed response message (not shown) to confirm receipt of the posting item from the posting module 580b.

FIG. 5C is an exemplary message diagram for generating an interactive map comprising listing data and real estate service providers in accordance with one embodiment. The message flow of FIG. 5C shows messages exchanged between several entities, which can be included in a real estate search and listing system. For ease of explanation, the number of entities shown has been limited. However, it will be understood that additional entities can be added or multiple entities combined consistent with the description herein.

Messaging 522 may be performed by allowing a user of a client device to submit a search request. In one embodiment, a user of a client device executing application code and utilizing the client device search module 560a to search for real estate and relevant real estate service providers located in close proximity to a specific geographical area of interest. The client device search module 560a allows a user to input, by means of a user interface, search criteria, including geographic data information. The client device search module 560a does not have access to the real estate data to be presented to the user and as a result must transmit a request to the communication server 502 in order to handle the user's request to search. The client device search module 560a transmits a search request message 522 to the communication server 502 where it's handled by the server search module 560b, which accepts the request and handles further processing of the request.

Messaging 523 may be performed by requiring the server search module 560b to transmit a datastore request 523 to the datastore 504. In one embodiment, the server search module 560b will transmit a listing request 523, which includes the search criteria received from the client device search module 560a to the datastore 504 in order to retrieve listing data that corresponds to the search criteria.

Messaging 524 may be performed by transmitting a datastore response 524 to the server search module 560b, which includes listing data that corresponds to the search criteria. In one embodiment, the Datastore 504 may transmit a listing response message 524 to the server search module 560b which includes active listing data collected from at least one external listing data server 540, of which the listing data therein have been indexed and stored in the datastore 504 for quick retrieval.

Message 526 may be performed by requiring the server search module 560b to transmit a map data request 526 to the server map data module 552b. In one embodiment, the server search module 560b will transmit a map data request 526 which includes the search criteria received from the client device search module 560a in order to retrieve map data that corresponds to the search criteria.

Message 527 may be performed by transmitting map data response 527 to the server search module 560b, which includes map data that corresponds to the search criteria. In one embodiment, the server map data module 522b may transmit a map data response message 527 to the server search module 560b which includes map data collected from at least one external map data server 550, of which the map data therein are accessible via an application programming interface.

Message 529 may be performed by transmitting a ranking request 529 from the server search module 560b to the server ranking module 590. In one embodiment, the search module 560b transmits a ranking request 529, which includes the search criteria received from the client device search module 560a in order to retrieve real estate service provider data that corresponds to the search criteria. The ranking module 590 will analyze the ranking request 529 and will query for the highest-ranking (in example, top 5, top 10, top 20, etc.) service providers that fit the search criteria.

Message 530 may be performed by transmitting a ranking response message 530 from the server ranking module 590 to the server search module 560b in order to provide a response to the ranking request message 529. In one embodiment, the server ranking module 590 may transmit a ranking response message 530 to the server search module 560b which includes the highest ranking service providers that meet eligibility requirements to the search criteria. The ranking response message 530 containing the highest ranking service providers may include information, such as, the name of the high ranking service provider, the photo of the high ranking service provider, the last textual post of the highest ranking service provider, the ranking score of the high ranking service provider, the office location/geo-location/last posting location of the high ranking service provider, or other identifying elements that may be available within the user profile of the service provider.

Message 531 may be performed by transmitting listing data, map data and service provider ranking information from the server search module 560b to the client device search module 560a. In one embodiment, the search request 522 will receive a search response 531 which contains information that is to be expected, which meets the search criteria, and providers the user with an interactive map which meets the user's search criteria, listing data which meets user's search criteria, and service provider data which meets user's search criteria.

In addition, if the user requesting the search request 522 is a real estate service provider, then a subsequent message (not shown) would be transmitted to the ranking module 590 from the search module to inform the ranking module to recalculate the user's quality score and overall ranking due to the user's active usage of the application.

FIG. 6 is a functional block diagram of an exemplary wireless real estate search system 600 in accordance with one embodiment. Few of the elements within the real estate search system 600 may have similar functionality as represented within the client device 510 and the communication server 502 (in general, the processor 630a/630b, the memory 640a/640b, the transceiver 650a/650b). However, the majority of the elements within the real estate search system 600 may be configured such that the client device 510 initiates a request, which is transmitted to the communication server 502 corresponding module for handling and further processing.

The account module 585a is configured to permit a user (for example, real estate service provider) to update their account profile information by means of the client device 510 with the communication server 502. In one embodiment, a user may initiated a user account/profile update request, to update their name, address, contact information, availability, listings (properties currently or previously listed for sale), executive summary, education, license number, personal website, or active zip codes for which they manage, or other user profile characteristics. The account module 585b is configured to handle the user account/profile update request by transmitting the received data within the request to the datastore 504 for storage and update the user account information globally, so that other users accessing the application may be able to review the updated information.

The search module 560a is configured to permit a user to transmit by means of a client device 510 to the communication server 502 a search request for either properties, real estate service providers, or both. In one embodiment, a user may initiate a user search request to search for properties within a geographic area of interest. The search module 560b is configured to handle the search request by requesting data from the datastore 504, listing data module 542, and/or the map data module 552 in order to generate a response back to the initiating client device 510 which includes map data, listing data, and/or service provider data. In another embodiment, a user may initiate a user search request to search for real estate service providers within a geographic area of interest. The search module 560b is configured to handle the search request by requesting data from the datastore 504, listing data module 542, the map data module 552, and/or ranking module 590 in order to generate a response back to the initiating client device 510 which includes map data, service provider data, and/or ranking data. In yet another embodiment, a user may initiate a user search request to search for listed properties and real estate service providers within a geographic area of interest. The search module 560b is configured to handle the search request by requesting data from the datastore 504, listing data module 542, the map data module 552, and the ranking module 590 in order to generate a response back to the initiating client device 510 which includes map data, listing data, service provider data, ranking data.

The posting module 580a is configured to permit a user to tag active or inactive geographic regions; upload contents such as images, audio, video, and text; and provide geo-location information to be transmitted by means of the client device 510 to the communication server 502 posting module 580b. In one embodiment, a user may initiate a post request to post specific text and upload one image to one zip code the user manages. The posting module 580b is configured to handle the search request by transmitting the data received in the request to the datastore 504 for long-term storage/accessibility, and then update the user profile information managed by the account module 585b. In addition, the newsfeed module 620a/620b will be updated to display the recent user posting. Moreover, the user ranking will be revised as determined by the ranking module 590. Thus, as a result of one post request, at least four modules within the communication server 502 are affected.

The chat module 570a is configured to allow users to communicate with one another in one-on-one or one-to-many format. In one embodiment, a user initiates an initial chat request to chat with another user by means of the client device 510. The chat request is then transmitted to the communication server 502 chat module 570b, which handles the request, to archive the chat request to the datastore 504, and transmit a secondary chat request to a target device based upon the initial chat request. Upon receiving the secondary chat request, the target device user may determine to ignore the chat request or respond back to the chat request. The chat requests are monitored, and stored in the datastore 504 for each user. In addition, a user account may be updated as a result of a chat request. The ranking module 590 may also adjust a user-ranking based upon chat usage or absence of chat usage. Thus, as a result of one chat request, at least three modules within the communication server 502 are affected.

The newsfeed module 620a is configured to permit users to view real-time postings of real estate service providers as related to a specific search criterion. In one embodiment, a user may be interested in properties in a specific zip code, i.e. 92129, as listed in his user preferences or based on recent search requests, wherein newsfeed (or recent postings from real estate service providers, or data related to real estate within the specified geographic region) is displayed to the user. The newsfeed is an aggregation of listing and posting data, or relevant real estate data, or advertisements, filtered based upon geographic region displayed to users looking for real estate information in real-time. The users may be able to initiate a chat request based upon information received within the newsfeed module 620a. The client device 510 newsfeed module 620a is configured to display data received from the communication server 502 newsfeed module 620b. The communication server 502 newsfeed module 620b is configured to aggregate listing data, posting data, relevant real estate data made available by real estate service providers or from external sources, and advertisements from advertisement module (not shown) based upon a geographic region.

The ranking module 590 is configured to generate a user overall ranking score based upon a user post score and a user quality score. The user post score and quality scores may be equality or unequally weighted in order to generate an overall ranking score for a user.

A user post score is a score, which may be determined based upon the text description for which a real estate service provider posts using the posting module 580a. The user post score may be determined based upon a dictionary and a parser, wherein the textual content of a user post is parsed by a parser when received within the communication server 502 posting score analysis module 591 and each word, a group of words, or entire content of the posted text string is analyzed for positive or negative determination. If a post score analysis module 591 determines the most recent user post contains content, which should be elevate the current post score for a user, then the current post score for a user is adjusted in response. Similarly, if a post score analysis module 591 determines the most recent user post contains content, which should be decrease the current post score for a user, then the current post score for a user is adjusted in response. The dictionary or libraries used in the post score analysis module 591 may utilize categories for which to classify overall or portion of the post content. The possible post categories may be market, finance, demographic, social, and property. The posts will have words with which to identify where the current post should belong in terms of category based on the words use in the post, this can be learned or determined based on which library/dictionary is being used.

A user quality score is a score, which may be determined based upon the user interaction with the application, or lack thereof, captured and analyzed by the quality score analysis module 592. The user quality score may be based upon completeness of user profile, application utilization, postings behavior, chatting behavior, commenting behavior, and content of information, which is transmitted by means of the client application. The quality score module 592 will have a plurality of sensors, pre-determined categories and respective score value associated to actions permitted within the application. If a quality score analysis module 592 determines the most recent user action should raise the current quality score for a user, then the current post score for a user is adjusted in response. Similarly, if a quality score analysis module 592 determines the most recent user action should decrease the current quality score for a user, then the current quality score for a user is adjusted in response. Alternatively, if the quality score analysis module 592 determines that most recent user action should not affect the current quality score for the corresponding user, then the current quality score for the corresponding user is unchanged in response to the action performed by the user.

The memory 640 may include both read-only memory (ROM) and random access memory (RAM). A portion of the memory 640 may also include non-volatile random access memory (NVRAM).

The processor 630 may also be referred to as a central processing unit (CPU). The processor 630 may perform logical and arithmetic operations based on program instructions stored within the memory 640. The instructions in the memory 640 may be executable to implement aspects of the methods described herein.

The elements included in the real estate search system 600 may be coupled by a bus 299. The bus 299 may be a data bus, communication bus, or other bus mechanism to enable the various components of the real estate search system 600 to exchange information.

The real estate search system 600 may also include a transceiver 650. The transceiver 650 may include a transmitter and a receiver configured to transmit and receive data between the real estate search system 600 and a remote location. The transceiver 650 may be configured for wired, wireless, or hybrid wired/wireless communication. In some implementations, the transceiver 650 may include one or more of an antenna, a network interface controller, a signal generator, an amplifier, and a signal filter.

Word analysis for posts to determine ratings and gain understanding of what is actually being posted requires an in depth understanding of sentence structure and parts of speech. To gain an advantage over other word analysis systems, each word or word combinations are tracked and traced to a set of dictionaries, which represent the breakdown of the word or word phrases. Word or word phrases that have exactly the same meaning will have the same number code. These words or word phrases can be represented in a single dictionary with a four-digit code, much like an ip address, or in separate dictionaries where every code (the first two digits anyway) is a separate dictionary.

For starters, separate dictionaries have been built to separate words in categories and parts of speech. This is described in the Table 1—Parts of Speech.

TABLE 1
Parts of Speech

```
  1. NOUNS (FIRST FOUR OVERLAP IN CATEGORIES) “1”
    SINGULAR OR PLURAL
    PROPER (CAPITALIZED) “0.1” OR COMMON “0.2”
    CONCRETE “0.01” OR ABSTRACT “0.02”
    COUNTABLE “0.001” OR UNCOUNTABLE “0.002”
    GERUND (ENDING IN-ING)
    MOST OF REAL ESTATE TERMS (14)
  2. PRONOUNS
    SINGULAR OR PLURAL
    1. PERSONAL “0.1”
    2. RELATIVE “0.2”
    3. DEMONSTRATIVE “0.3”
    4. INDEFINITE “0.4”
    5. REFLEXIVE “0.5” (NEVER NEXT TO NOUN OR PRONOUN)
    6. INTERROGATIVE “0.6”
    7. POSSESSIVE “0.7”
    8. RECIPROCAL (TWO WORDS: EACH OTHER AND ONE
    ANOTHER “0.8”)
    9. INTENSIVE (SAME AS REFLEXIVE, BUT IS PLACED IN
    FRONT OF NOUN OR PRONOUN)
  3. ADJECTIVES
    COMPARATORS (COMMONLY END IN -ER)
    SUPERLATIVES (COMMONLY END IN -EST)
    PROPER (USUALLY CAPITALIZED)
    COMMON
      APPEARANCE
      COLOR
      FEELINGS
      SHAPE
      SIZE
      SOUND
      TIME
      TASTE
      TOUCH
      QUANTITY
    NUMBERS OR NUMERALS (10)
    REAL ESTATE ADJECTIVES (13)
4. ADVERBS
    COMMON
    MANNER
    PLACE
    PURPOSE
    FREQUENCY
    TIME
    COMPLETENESS
  5. CONJUNCTIONS
    COORDINATING
    CORRELATIVE
  6. PREPOSITIONS
  7. VERBS
    ACTION OR LINKING
    MAIN OR AUXILIARY (HELPING)
    TRANSITIVE OR INTRANSITIVE
    MOST OF INTERJECTIONS (9)
  8. ARTICLES (ONLY THREE: A, AN AND THE)
  9. INTERJECTIONS (ATTENTION GRABBERS)
10. NUMBERS OR NUMERALS
11. CONTRACTIONS (SUBJECT VERB COMBO)
12. TIME
13. REAL ESTATE ADJECTIVES
14. REAL ESTATE TERMS
15. DEMOGRAPHIC WORDS
16. FINANCE WORDS
17. MARKET WORDS
18. PROPERTY WORDS
19. SOCIAL WORDS
20. PUNCTUATION (. ? ! , : ; ( ) / ‘ “)
21. SYMBOLS (@ % $ & * + = > < )
```

Thus, the first two digits of the four-digit code will represent “part of speech” and “category”, respectively. Note that word and word phrases can be numbers and symbols as well, and special attention is paid to phone numbers, email addresses and website addresses. To avoid over populating the database, all phone numbers are converted to ###/###-####, all email addresses are converted to name@location.site, and all websites are converted to www.website.com. The third number in the code refers to occurrence frequency and the fourth number refers to connectivity make-up. These will be describes more thoroughly below.

Many parts of speech has subcategories, such as nouns can be “abstract” or “concrete” and “proper” or “common.” These categories can be mutually exclusive or not and provide specific information as to their impact on language understanding. Thus, each of these subcategories will be embedded in the parts of speech number and reference a specific knowledgebase when each of these subcategories is encountered. The set of subcategories and categories form a relationship of order and content in a sentence. When these are activated, the set can give us clues to the representation of the sentence make-up and we will attempt to fill in the blanks as to whether the sentence is simple, compound, complex or compound complex.

Compound sentences are made-up of conjunctions and complex sentences have some prepositional phrases. Conjunctions form high-level linkages and prepositional phrases describe a relationship among the objects of a sentence. In addition, nouns and pronouns represent the “what” or “subject/object” of a sentence. It may also represent where if there is location information attached to the nouns, which gives the “where”, and if the subject is a person then the information of “who” is represented. The verbs represent the “how” of “action” of a sentence. The sentences tense, or mention of a time interval, specific time or frequency of occurrence in a sentence represents the “when” of a sentence or phrase. Comparative adverbs and adjectives can give insight into “why” one object or objects is better than another.

A post will be considered as a means of communicating information to many, so the sentence structure if maintained within a set of boundaries that can be decomposed into a code which populates a database of knowledge. This knowledge will be composed of (1) “where” information that can be about a specific residence's location, a neighborhood or a region, and/or (2) “who” information about a specific person, a community, or a service in the community, and/or (3) “what” information when communicating about a residence, specific attributes about that residence, or abstract knowledge about the place or places in question, and/or (4) “how” information that can be convey knowledge in acquiring a property, discovering activities in a neighborhood, or explaining some experience that may prove helpful, and/or (5) “when” information, which includes a schedule of events, a specific time interval or just a timeframe, and/or (6) “why” information that shows comparisons among a set of options to help one choose a proper course of action that suits them.

Given the nature of language many books will have been read by the system for it to learn proper grammar and provide a fuller database of words and phrases. This will provide two important metrics for language understanding. One is the frequency of occurrence of each word or phrase, and the other is the connectivity with nearby words. As mentioned above the frequency of occurrence is the third number within the code.

The connectivity of high frequency words provides far better meaning when two or three high frequency words are linked, such as prepositional phrases. The linkages of words can be learned by example through computer reading of well-structured text. This aids in the decomposition of sentences by reducing the number of patterns in a sentence to smaller compressed set. For example, simple words such as articles “a”, “an” and “the” are better off linked with their neighbors to give a more distinct meaning The linkage pattern will be the fourth number in the coded dictionary for a specific word or phrase.

In Table 2 illustrates 25 currently developed dictionaries. However, this disclosure assumes that more dictionaries may be added, or some dictionaries removed in order to optimize the post score. The post scores for the terms in each dictionary may be defined by a specific score or can be learned by the system when a plurality of posts are parsed and reviewed.

TABLE 2
Dictionary List

| Code | | | |
|---|---|---|---|
| Number | Dictionaries | Alpha Parameter | Beta Parameter |
| 1 | Common Nouns | 0 | 0 |
| 2 | Pronouns | 0 | 0 |
| 3 | General Adjectives | 1 | 1 |
| 4 | Adverbs | 0 | 0 |
| 5 | Conjunctions | 1 | 1 |
| 6 | Prepositions | 1 | 1 |
| 7 | Verbs | 0 | 0 |
| 8 | Articles | 0 | 0 |
| 9 | Interjections | 0 | 0 |
| 10 | Number of Numerals | 0 | 1 |
| 11 | Contractions | 0 | 0 |
| 12 | Time Words | 1 | 1 |
| 13 | Real Estate Adjectives | 1 | 3 |
| 14 | Real Estate Terms | 2 | 4 |
| 15 | Demographics | 2 | 2 |
| 16 | Finance | 2 | 2 |
| 17 | Market | 2 | 2 |
| 18 | Property | 2 | 2 |
| 19 | Social | 2 | 2 |
| 20 | Symbols | 2 | 2 |
| 21 | Punctuations | 0 | 0 |
| 22 | Proper Nouns | 0 | 0 |
| 23 | Tourist Terms | 0 | 0 |
| 24 | Bad Dictionary | −100 | −1000 |
| 25 | Bad Short Cuts | −1 | −10 |

In one embodiment, an example post: “This house has stainless steel appliances.” In this simple example, the length of the phrase in the dictionary is equal to the score. Such as, “stainless steel appliances” is in the dictionary so that scores 3 points. “Appliances” is also in the dictionary so that scores 1 point and “house” is in the dictionary so that also scores 1 point. Thus, the total for this example is 5 points. In another embodiment, each user post can be analyzed as a single post and each word can be given equal value and the terms in the dictionary can be weighted equally.

User Post Score if a user has never posted may be a neutral or zero value. When a user does actively post items to specific geographic region, the each post item will generate either a positive or negative post score that will be summed with the user current post score that specific geographic region. In one embodiment, if a user has a current post score of “5” for zip code “92129, and subsequently generates a posting item for geographic region “92129” the post score for the posted item will be summed in with the current post score of “5” for zip code “92192”. In one embodiment, user A has a current overall post score 5 for 92129, user A posts a post item for 92129 and generates a post item score of 10 as a result, user A current post score (15) for 92129=previous post score (5) for 92129+current post item score (10) for 92129. Thus, each post item (linked to a geographic region) will generate a post item score, which will be summed into the user's previous overall post score (for the same geographic region) in order to generate an updated (current) overall post score (for the same geographic region). As a result, a user may have multiple overall post scores for different regions that the user has identified in his user profile or tagged (linked) to his prior postings.

The dictionary terms can be changed and the score for each entry can be changed as well. In another implementation, a validation application may be added to enhance the post score analysis, which gives a breakdown of the score and allows the user to add or delete dictionary terms.

Grammar correctness is measured through the use of cogency. Cogency works as follows: a large matrix with single words and symbols on both the rows and columns. Words and symbols are called tokens. There is a matrix for each distance of these tokens. For example, tokens next to each other, at a distance of two, a distance of three, etc. At most we will consider a distance of ten to account for the longest phrases as possible. Thus, we could have ten matrixes. The matrix is square and there are n² elements where n is the number of tokens. Each row in the matrix gives the occurrence of one token may be matched with another in forward direction. Each column represents the occurrence of a token matched with another in the reverse direction. The tokens are listed in the same order for both rows and columns so that the diagonal represents the same token matched with another in both directions. In addition, the vector of length n is kept to keep track of the number of occurrences of each token. The probability of any two tokens at a given distance is determined by selecting the appropriate matrix and the probability that the tokens are at that distance is the value of the element divided by the sum of the row for the forward direction and divided by the sum of the column for the reverse direction. Thus, if the probability for all combinations of tokens within a post is measured to be above zero, then the grammar is considered correct. The number of combinations to check is based on the length of the post. If the post if of length m and we have 10 matrices, then the number of elements to check is 0 for m=1, 2 for m=2, 6 for m=3, 12 for m=4, 20 for m=5, etc. More explicitly, the number of checks is two times the sum of m−11 to m−1, where m is greater than ten; otherwise it is two times the sum from 1 to m−1. In the future, the old post score will be reduced by multiplying by some grammar factor, which is a multiplication of all these elements together. Thus, a zero would reduce the grammar to a zero score factor.

In another embodiment of the disclosure, the user posts will be scored more based on content than the individual words used. Here is an example for determining the value of time in a sentence:

This is useful for determining when an event or events are taking place. This may expressed using a regular expression, because there are many combinations of what can be said. The ‘#’ sign represents a digit. Here are some examples of what could be in a post:
For time intervals:
{‘#’, ‘##’}, {‘ ’, ##’}, {‘ ’, ‘am’, ‘pm’, ‘o′clock’}, {‘-‘, ‘to’, ‘yhru’, ‘through’}, {‘#’, ‘##’}, {‘ ’, ’:##’}, {‘ ’, ‘am’, ‘pm’, ‘o′clock’},
For a specific day:
{‘last’, ‘this’, ‘next’}, {‘sun’, ‘mon’, ‘tue’, ‘tues’, ‘wed’, ‘thu’, thur’, ‘thurs’, ‘fri’, ‘sat’}
For a reoccurring day:
‘every’, {‘sun’, ‘mon’}, ‘tue’, ‘tues’, ‘wed’, ‘thu’, thur’, ‘thurs’, ‘fri’, ‘sat’} (frequency of time)
Over several moths:
{‘jan’, ‘january’, ‘feb’, ‘february’, ‘mar’, ‘march’, ‘apr’, ‘april’, ‘may’, ‘jun‘, ‘june’, ‘jul’, ‘july’, ‘aug’, ‘august’, ‘sep’, ‘sept’, ‘september’, ‘oct’, ‘october’, ‘nov’, ‘november’, ‘dec’, ‘december’}, {‘-’, ‘to’, ‘thru’, ‘through’}, {‘jan’, ‘january’, ‘feb’, ‘february’, ‘mar’, ‘march’, ‘apr’, ‘april’, ‘may’, ‘jun’, ‘june’, ‘jul’, ‘july’, ‘aug’, ‘august’, ‘sep’, ‘sept’, ‘september’, ‘oct’, ‘october’, ‘nov’, ‘november’, ‘dec’, ‘december’} (date interval)
Over several seaons:
{‘spring’, ‘summer’, ‘fall’, ‘winter’}, {‘-’, ‘to’, ‘thru’, ‘through’}, {‘spring’, ‘summer’, ‘fall’, ‘winter’} (seasonal interval)
Over several years:
}‘####’, ‘ ’##’}, {-}‘, ‘to’, ‘thru’, ‘through’}, {‘####’, ‘ ’##’, ‘##’} (years interval)
   These regular expressions must also be built for other areas of the dictionaries and not just for time, as shown and described above. These expressions will allow for a knowledge base to be filled to determine best what has been posted.

The application may incorporate at least 25 integrity accountability factors (IAF) in order to determine the user's quality score. The 25 integrity accountability factors may comprise those listed in Table 3 below.

TABLE 3
Integrity Accountability Factors (IAF) Summary

| | |
|---|---|
| 1. | Synergistic - Provides valuable input to improve agent community and real estate search |
| | and listing system effectiveness |
| 2. | Knowledgeable - Shows exemplary knowledge and responsible reporting in assigned zip |
| | codes |
| 3. | Modesty - Does not boast about themselves or post solely to be heard |
| 4. | Feedback - Shares valuable information that continually improves real estate search and |
| | listing system |
| 5. | Balanced - Makes use of all the features available within the real estate search and listing |
| | system |
| 6. | Agile - Can handle any reasonable unique customer types and needs |
| 7. | Pragmatic - treats all clients directly with their issues and with due diligence and equity |
| 8. | Learning - keeps pace with application improvements and modifications |
| 9. | Consistency - stays connected regularly and updates and/or clears outdated information |
| 10. | Approachable - is referred to often by real estate service providers or clients, a good |
| | listener and problem solver |
| 11. | Transparent - shares information freely and does not withhold helpful feedback |
| 12. | Temperance - does not overreact or under appreciate interactions |
| 13. | Cooperative - knows own limitations and others enough to direct proper correspondence |
| 14. | Purposeful - posts and chats add value and seldom subtracts from conversation |
| 15. | Genuine - authentic and consistent in actions and conversations |
| 16. | Respectful - nonjudgmental chat, appreciates quality feedback, and never attacks |
| | character |
| 17. | Complete - provides context to information and fills in all available knowledge |
| 18. | Responsive - responds to good clients in a timely manner as suits their needs |
| 19. | Accurate - information is specific and verifiable when possible |
| 20. | Novelty - information is new or unique and not already posted somewhere else |
| 21. | Effective - posting useful information and keeping pace with demands |
| 22. | Resolute - closes on issues and follows through on commitments |
| 23. | Organized - gives precedence to those who come first or does not forget them |
| 24. | Engaging - customers are motivated through the engagement of the agent |
| 25. | Content - self-satisfaction and acknowledgement -- can pass on work when plate is full |

The 25 integrity accountability factors are described in details in Table 4 below.

TABLE 4
Integrity Accountability Factors (IAF) Detail

| | |
|---|---|
| 1 | Synergistic - Provides valuable input to improve real estate service provider |
| | community and application effectiveness |
| | Sharing valuable tips to other real estate service providers in the field |
| | Bringing more real estate service providers into the system |
| 2 | Knowledgeable - Shows exemplary knowledge and responsible reporting in assigned |
| | zip codes |
| | Typically shares valuable information in area of interest |
| | Is the person addressed when specific questions arise about area of |
| | interest |
| 3 | Modesty - Does not boast about themselves or post solely to be heard |
| | Does not exaggerate a situation or information (avoids superlatives when |
| | possible) |
| | Does not advertise about themselves or anything unrelated to real estate |
| | search and listing system's objectives |
| 4 | Feedback - Shares valuable information that continually improves real estate search |
| | and listing system |
| | Shares ideas to the agent community on improving rating system |
| | Adds valuable qualified and/or quantifiable features to the system |
| 5 | Balanced - Makes use of all the features available in client application |
| | Shows competence in using the latest features |
| | Does not game the system to achieve a higher rating |
| | Avoids automated responses or cut and paste communication |
| 6 | Agile - Can handle any reasonable and unique customer types and needs |
| | Has a track record on taking on all types of customers/handling their |
| | needs as desired |
| | Valuation will be tracked as variability in using toolset and happiness of |
| | customers |
| 7 | Pragmatic - treats all clients directly with their issues and with due diligence and equity |
| | Information is directly related to the subject matter and avoids tangential |
| | discussions |
| | When possible, shares with all whom need info and answer with equal |
| | due diligence |
| 8 | Learning - keeping pace with application improvements and modifications |
| | Embraces changes in the application that contributes to the real estate |
| | service providers as a community |
| | Shows a proficiency in most/all the tools available within the system |
| 9 | Consistency - stays connected regularly and updates and/or clears outdated information |
| | Stale information that contradicts new information needs to be cleared or |
| | updated |
| | Frequency of communication is tracked and monitored |
| 10 | Approachable - is referred to often by real estate service providers or clients, a good |
| | listener and problem solver |
| | Frequency of inclusion on discussions and references to their posts |
| | Much positive feedback from clients and other real estate service |
| | providers (has good citizenship skills) |
| 11 | Transparent - shares information freely and does not withhold helpful feedback |
| | The breadth and depth of information provided is on par or better than |
| | other real estate service providers |
| | Communicates in broadcast mode when appropriate to keep all informed |
| 12 | Temperance - does not overreact or under appreciate interactions |
| | Expressions used are informative without exaggeration |
| | Avoids unsubstantiated rumors and speculation and attenuates volatile |
| | situations |
| 13 | Cooperative - knows own limitations and others enough to direct proper |
| | correspondence |
| | Displays knowledge of best fitting personal role and the roles of others |
| | in organization |
| | Displays quality correspondence to others and measured by community |
| | benefits |
| 14 | Purposeful - posts and chats add value and seldom subtracts from conversation |
| | Information posted has a clearly defined and articulated purpose |
| | An individual rating that measures directness and value of information |
| | posted |
| 15 | Genuine - demonstrates a consistent behavioral theme in actions and conversations |
| | Sincere and just in resolving issues |
| | Displays authenticity in discussions by continually adding value |
| 16 | Respectful - nonjudgmental chat, appreciates quality feedback, and never attacks |
| | character |
| | maintains rapport with others |
| | Takes feedback seriously and adequately addresses issues |
| 17 | Complete - provides context to information and fills in all available knowledge |
| | Fills out all important aspects of information available (e.g., property) |
| | Takes the opportunity to add broader and/or deeper information (e.g., |
| | tags images) |
| 18 | Responsive - responds to clients in a timely manner as suits their needs |
| | The response times are timely and consistent, and no one is forgotten |
| | Has productive availability times that suit the needs of the clients |
| 19 | Accurate - information is specific and verifiable when possible |
| | Adding information to other posts while giving credit to original posts |
| | Posting corrections and adding specifics when available |
| 20 | Novelty - information is new or unique and not already posted somewhere else |
| | New information or a new perspective on old information is valued |
| | Anomaly detection will be used to flag unique information |
| 21 | Effective - posting useful information and keeping pace with demands |
| | Posts that leads to more interaction or views is valued |
| | Click and view counts are captured for rating effectiveness |
| 22 | Resolute - closes on issues and follows through on commitments |
| | Maintaining progress amenable to clients needs (track inferred |
| | milestones) |
| | Promises made are tracked and scored when issues are resolved |
| 23 | Organized - gives precedence to those who come first and does not forget anyone |
| | Real estate service providers are demonstrating an efficient use of time |
| | on the system |
| | Based on self-set styles, real estate service providers can be graded on |
| | their follow-through |
| 24 | Engaging - customers are motivated through the engagement of the agent |
| | Depth of interaction is measured via chat and postings (progression |
| | counts) |
| 25 | Content - self-satisfaction and acknowledgement - can pass work to others when |
| | appropriate |

The overall ranking of real estate service providers to customers is a complex task that requires a variety of perspectives and metrics to meet a wide array of accountability measures. To start, we have the perspective of a timeline. This timeline is divided into three computational levels. The first level of accountability is the tactical level. These are values that are measured as snapshots of previous events. Thus, the real estate service provider's actions are considered reactionary and are measured at each instance or time step. The second level of accountability is the operational level. These are values that are measured over time, but have a finite time length and a small discrete set of featured inputs. In other words, the metrics are over a window of time and measure the change in behavior of real estate service providers in the short-term. The third and final level of accountability is the strategic level. These values are measured over the entire course of the real estate service provider and represent the totality of their work. The values measured in these three areas are shown in Table 5 below.

TABLE 5
Integrity Accountability Metrics
Integrity Accountability Metrics

| | | |
|---|---|---|
| Strategic | Operational | Tactical |
| Synergistic | Approachable | Organized |
| Learning | Genuine/Authentic | Effective |
| Flexible/Agile | Temperate | Novel/Innovative |
| Balanced/Moderation | Cooperative | Resolute |
| Engaging | Consistency | Modest |
| Knowledgeable | Transparency | Respectful/Inclusive |
| Pragmatic | Responsive | Accurate |
| Feedback | Purposeful | Complete |
| | | Content |

The values shown in this table requires a set of features and baselines. Since this application is in real estate, the features are directly related to real estate. Below is a list of features currently being considered, as shown in Table 6:

TABLE 6
Features

| | |
|---|---|
| 1 | Property type general (Lot/Land/Commercial/Residential) |
| 2 | Property type specific (Apartment/Condo/Loft/Townhouse/Detached/ |
| | Co-op/Multi-family/detached duplex/2on1 duplex/triplex/fourplex) |
| 3 | Acquisition type (Timeshare/Lease/Sale/Foreclosure) |
| 4 | Sizes (Lot, House, Bedrooms, Bathrooms, Garages, Patio, and |
| | additional covered spaces) |
| 5 | Year Built (new construction/specific date/range of values) |
| 6 | Property Amenities (Fireplace, Pool, etc.) |
| 7 | Prices (specific/range) and price changes (up/down/steady) |
| 8 | Additional Costs (Taxes/Insurance/HOAs/Mello-Roos) |
| 9 | Neighboring home density (urban/suburban/country/etc.) |
| 10 | Neighboring home styles (high-rise/ranch/track homes) |
| 11 | Open Houses (when? where?) |
| 12 | Time on Market (compared to?: neighborhood, zip code, etc.) |
| 13 | Schools (district/type/ratings/commute) |
| 14 | Crime stats (violence/accidents/theft/emergency time delay) |
| 15 | Traffic stats (hourly/work/shopping commute/etc.) |
| 16 | View (from where?: balcony/bedroom/etc. and of what?: scenery) |
| 17 | Quiet/Noisy (why?: cul-de-sac, a major thoroughfare, etc.) |
| 18 | Demography (Community resources/activities) |
| 19 | Culture Amenities (spoken languages/type of churches/cuisines/etc.) |
| 20 | Parks/Playgrounds (portion of area/within walking distance) |
| 21 | Accessibility (bikes/wheelchair/sidewalks/trails) |
| 22 | Restaurants (rating and density of options) |
| 23 | Other Nearby Amenities (rating for this) |
| 24 | Parking (personal/guests/availability/nearest) |
| 25 | Walk Score (based on a variety of interests) |
| 26 | Photos (of Listings/neighborhood/etc.) |
| 27 | Proximity to (fire station/police station/hospital/etc.) |
| 28 | Mortgage Rates (Finance Metric) |
| 29 | Mortgage Loan Guidelines (Finance Metric) |
| 30 | Approval Timelines (Finance Metric) |
| 31 | Loan Programs (Finance Metric) |
| 32 | Mortgage News (Finance Metric) |
| 33 | Home Loan Qualifying (Finance Metric) |
| 34 | Mortgage Process (Finance Metric) |
| 35 | Appraisals (Finance Metric) |
| 36 | Home Inspections (under property instead of lending) |
| 37 | Closing Escrow (Finance Metric) |

In regards to measuring these features to give a comparison to other places one is considering, comparisons of these features can be made by using the following baselines, as displayed in Table 7:

TABLE 7
Baselines

| | |
|---|---|
| 1 | Area (Radius (from GPS location)/Zip codes/etc.) |
| 2 | Continuous Timeline (days/weeks/months/years) |
| 3 | Frequency of Occurrence (over weeks/months/etc.) |
| 4 | Costs (ranges) |
| 5 | Sizes (ranges) |
| 6 | Selecting particular properties to compare (show differences) |
| 7 | Number of participants |
| 8 | Number of posts and/or comments |

The comparison of features using these baselines will give a variety of illuminating features for the customer to review at their leisure. This could be displayed as overlays on a map, in graphic form or just simply as features with specific numbers or ranges; whichever representation is most appropriate. For instance, one may want to know the average cost of a property in a geographic region simply by choosing prices as a feature and a zip code as the baseline. Many combinations of several features and baselines in combination can be chosen to give the customer numerous ways to use the application to keep interest and maintain loyalty to the real estate search and listing application.

In one embodiment, to integrate some of these characteristics into our system, four accountability metrics may be specified more distinctly. These accountability metrics are the Responsive, Engaging, Modest and Balanced Qualities. The overall ranking of a real estate service provider is not only dependent on the score of the contents of their chats and posts, but also dependent upon their overall interaction with the real estate search and listing application. Thus, along with the score of an individual post, the ranking of a real estate service provider will be the aggregation of the post scores with the quality scores given in evaluating their behavior.

Two of the Strategic Qualities are Balanced and Engaging. The Balanced Quality is based on how much and to what extent a real estate service provider uses the real estate search and listing application. The Balanced Quality description and scoring is described below in Table 8:

TABLE 8
Balanced Quality
Balanced Quality
Initiates/populates all aspects of profile and application usage

| Profile | Scores | Application Utilization | Scores |
|---|---|---|---|
| Address | 5 | Posted something | 20 |
| Title name | 5 | Comment on a post | 5 |
| Full name | 5 | Use chat | 20 |
| Email address | 5 | Did a search | 10 |
| Picture | 15 | View the service provider list | 5 |
| Bio brief | 30 | View the home listings | 10 |
| Mobile phone | 5 | View the newsfeed | 10 |
| License number | 15 | View locator map | 5 |
| Logo picture | 5 | Use center on map for search | 10 |
| Website | 5 | Does Market Index survey | 15 |
| Claim Realtor ID | 15 | Check in | 5 |
| All filled in bonus | 20 | Availability | 5 |

Balanced Rating = total points/(sum of total points for all service providers within geographic region)

The Engaging Quality is a measure of how much posting, chatting and commenting a real estate service provider does over the course of their use. The Engaging Quality description and scoring is described below in Table 9:

TABLE 9
Engaging Quality
Engaging Quality
Initiates and maintains conversations using posts, chats and comments

| Post | | | | | |
|---|---|---|---|---|---|
| Aggregated | Score | Chats | Score | Comment | Score |
| Tagged Media | 45 | Tagged Media | 20 | Tagged | 20 |
| Video | | Video | | Media | |
| | | | | Video | |
| Tagged Media | 30 | Tagged Media | 15 | Tagged | 20 |
| Photo | | Photo | | Media | |
| | | | | Photo | |
| Text: Sum of | 15 | Initiate Chat | 25 | Initiate | 35 |
| all post ratings | | | | Comments | |
| Bonus score for | 10 | Respond to Chat | 20 | Respond to | 15 |
| number of | | | | Comment | |
| posts | | Successive Chats | 10 | Successive | 5 |
| | | | | Comments | |
| | | Successive Chats 2 | 10 | Bonus for | 5 |
| | | | | number | |
| | | | | of comments | |
| | | Successive Chats 3 | 5 | | |
| | | Successive Chats 4+ | 0 | | |
| | | Bonus score for | 10 | | |
| | | number of chat | | | |
| | | responses | | | |

Engaging Rating = total points/(sum of total points for all real estate service providers within geographic region)

One of the Operational Qualities of importance is the Responsive Quality. This evaluates the use of chat and comments in the time domain. In other words, how well does the real estate service provider initialize and respond to other real estate service providers and customers? The Responsive Quality description and scoring is described below in Table 10:

TABLE 10
Responsive Quality
Responsive Quality
Responds to chats and comments to posts in a timely manner

| Chat (Responses) | Score | Post (Comments) | Score |
|---|---|---|---|
| within minutes | 35 | within minutes | 10 |
| within the hour | 15 | within the hour | 20 |
| within the day | 5 | within the day | 40 |
| within the week | −10 | within the week | 10 |
| when available | 7 | when available | 20 |
| To initiate chat message | 35 | Not at all | 0 |
| To subsequent chat message | 20 | | |
| Not at all | −20 | | |

Responsive Rating = total points/(sum of total points for all real estate service providers within geographic region)

An important Tactical Quality is the Modest Quality. This measures how a real estate service provider posts and chats at each instance. The Modest Quality description and scoring is described below in Table 11, and given the complexity of this quality, notes are displayed below the description.

TABLE 11
Responsive Quality
Modest Quality
Avoids boasting about themselves and use of flamboyant language

| Post | Score | Chat | Score |
|---|---|---|---|
| Uses declarative sentences (starts | 25 | Uses declarative sentences (starts | 25 |
| with noun or prep., and ends in “.”) | | with noun or prep., and ends in “.”) | |
| Ends a post with “!” | −15 | Ends a post with “!” | −10 |
| Ends a post with a “?” | −10 | Ends a post with a “?” | 0 |
| Posting phone number | −30 | Posting phone number | 0 |
| Posting an email address | −30 | Posting an email address | 0 |
| Begins sentence with command | −5 | Begins sentence with command | −5 |
| Uses comparators (e.g. better) | 20 | Uses comparators (e.g. better) | 20 |
| uses superlatives (e.g. best) | −20 | uses superlatives (e.g. best) | −10 |
| Uses second and third person | 20 | Bonus: Responds to interrogative | −5 |
| | | “?” with declarative sentence “.” | |
| uses first person | −20 | | |

Modest Rating = total points/(sum of total points for all service providers within geographic region)
Notes:
Promotes knowledge via descriptive writing in using declarative sentences
Answers interrogative statements (end in “?”) with a declarative response (end in “.”)
Avoids excessive use of exclamatory sentences (use of “!”) at end of post or chats
Avoids posting phone number or email address of self
Avoid giving commands through imperative sentences (verb at start of sentence and ends in “.”)
Avoids use of superlatives when describing nouns and uses comparators more

In one embodiment, to determine the quality score for a real estate service provider within a specific geographic region may be determined by using the following equation:

User quality score=(Synergistic Quality+Knowledgeable Quality+Modesty Quality+Feedback Quality+Balanced Quality+Agile Quality+Pragmatic Quality+Learning Quality+Consistency Quality+Approachable Quality+Transparent Quality+Temperance Quality+Cooperative Quality+Purposeful Quality+Genuine Quality+Respectful Quality+Complete Quality+Responsive Quality+Accurate Quality+Novelty Quality+Effective Quality+Resolute Quality+Organized Quality+Engaging Quality+Content Quality+Other Quality). More or less Quality categories may be utilized in order to determine the user quality score.

In one embodiment, a user searches for real estate agents from available real estate service providers within zip code “92129”, wherein there are 30 real estate agents within “92129” listed in their user profile as active zip codes for which they manage, the search results of the application will present to the user the top 10 relevant (highest ranking) real estate agents within “92129”. Each of the 30 real estate agents has a specific balanced quality score, engaging quality score, modest quality score, and responsive quality score. These scores can be summed together to generate an overall quality score for each of the 30 real estate agents. In order to determine which 10 real estate agents to present to the requesting user, the application will identify the 10 highest ranking real estate agents with the highest overall ranking score. The overall ranking score for real estate agents within “92129” may be determined using the following equation: (Post Score (92129) X weighted value)+(Quality Score×weighted value)=Overall Relevancy Score

The system will utilize user's knowledge and application usage to improve the functional and data-driven processes that will in response improve the system.

In one embodiment, the features and baselines previously described may relate to the search module, wherein when users utilize the search module, the system may analyze user search behavior, begin to learn about user's needs, and adapt to the user's needs. In one exemplary embodiment, the features may represent numerators and the baselines may represent denominators in a mathematical equation, wherein in a specific example, a potential buyer of real estate may know a few key items that would drive his purchase, but not all items of interest. In this instance, the user may search within the system for some combination of a feature or features with a baseline and narrow his search area. For instance, I want to live within walking distance of a coffee shop in San Diego. One could use a structured search to find the areas of interest for him if the features and baselines were made available to the user.

In another embodiment, the system may parse a user's key item of interest, for example, “I want to live within walking distance of a coffee shop in San Diego” and perform a search based on the algorithm described in the dictionary section. The dictionaries are may not only be used to score the posts, but rather may be used to decode information posted and searched to determine what information is gained in the system and what information is desired by a user. Thus, search can be used as a feedback mechanism to improve the system.

Moreover, the system may constantly be analyzing the long-term effects of matching real estate service providers and customers. In one exemplary embodiment, wherein the system provides a list of perspective real estate service providers to a user based upon a search criteria: the user reviews the real estate service providers provided within the interactive map, reviews the posts and chats related to the real estate service providers provided within the interactive map, but eventually decides to contact another real estate service provider notwithstanding the information provided. This user behavior can be interpreted as system feedback, wherein the system may be adjusted manually or automatically by means of tuning of weights of the dictionaries to rate posts and qualities metrics more effectively.

The post score and quality score may be configured based on application logic or pre-configured rules to dynamically modify individual post score items or quality score sub-items based on global user application usage and content of postings. In one embodiment, the application logic may be pre-configured to decrease or increase the post score of a posting item associated to at least dictionary by certain amount based on system feedback that globally users are more likely to post items related to content not available/available, respectively, within this posting item. The system may modify the post score by modifying the dictionary weight scores, by modifying the post item score, or modifying the user's overall post score (aggregation of all post item actions previously performed). In another embodiment, the application logic may be pre-configured to decrease or increase the quality score of an individual quality metric (such as, balanced quality) by adjusting the weighted value associated to the individual quality metric when calculating the overall quality metrics of a user. In another embodiment, the application logic may be pre-configured to decrease or increase the quality score of an individual quality metric (such as, balanced quality) by adjusting the scoring of the sub-category of items within the individual quality metric. In yet another embodiment, the quality score may be adjusted dynamically by combination of weighted metric quality value and adjustment to sub-category of items within an individual quality metric.

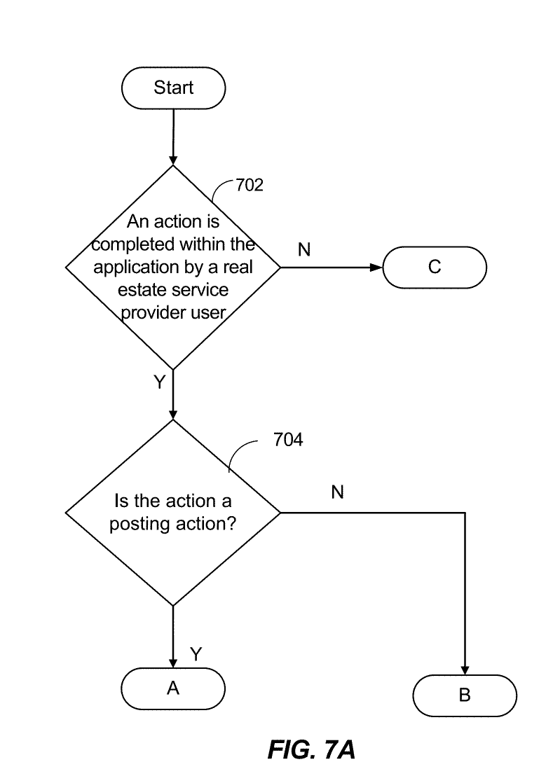

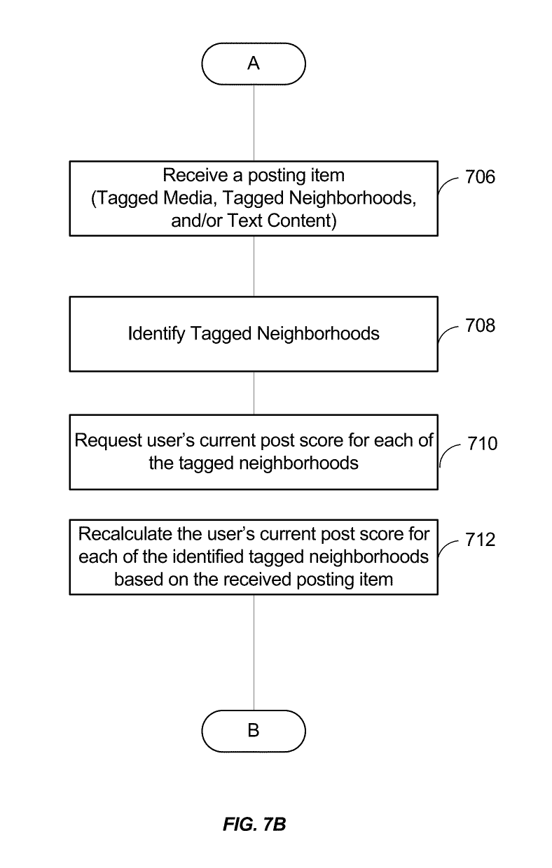

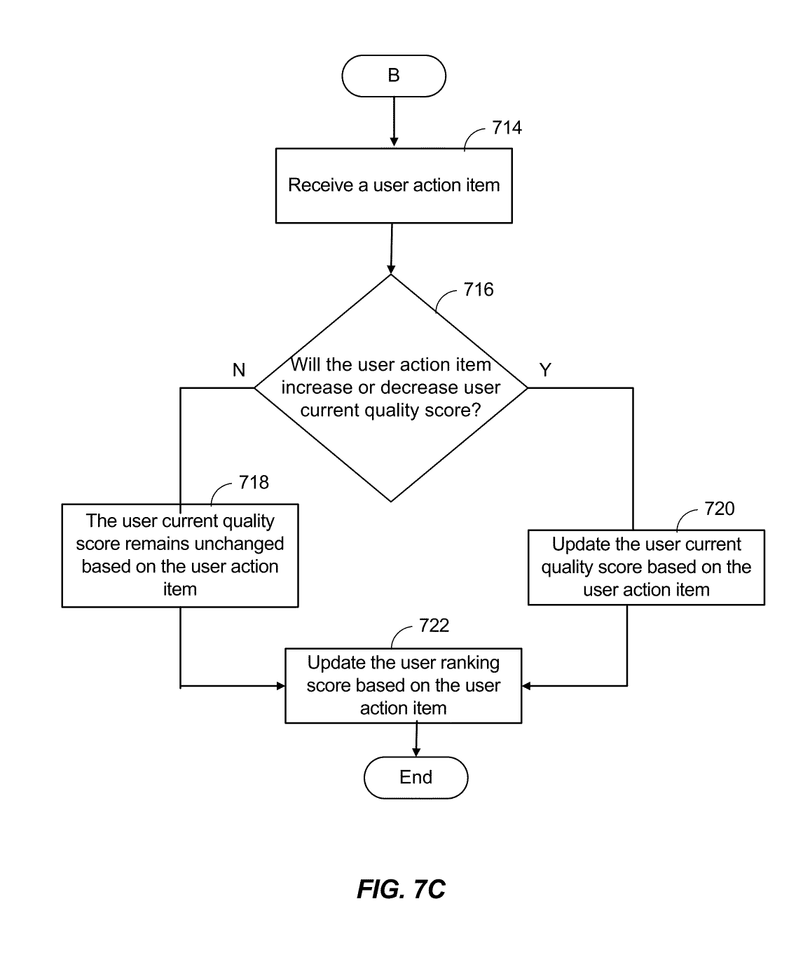

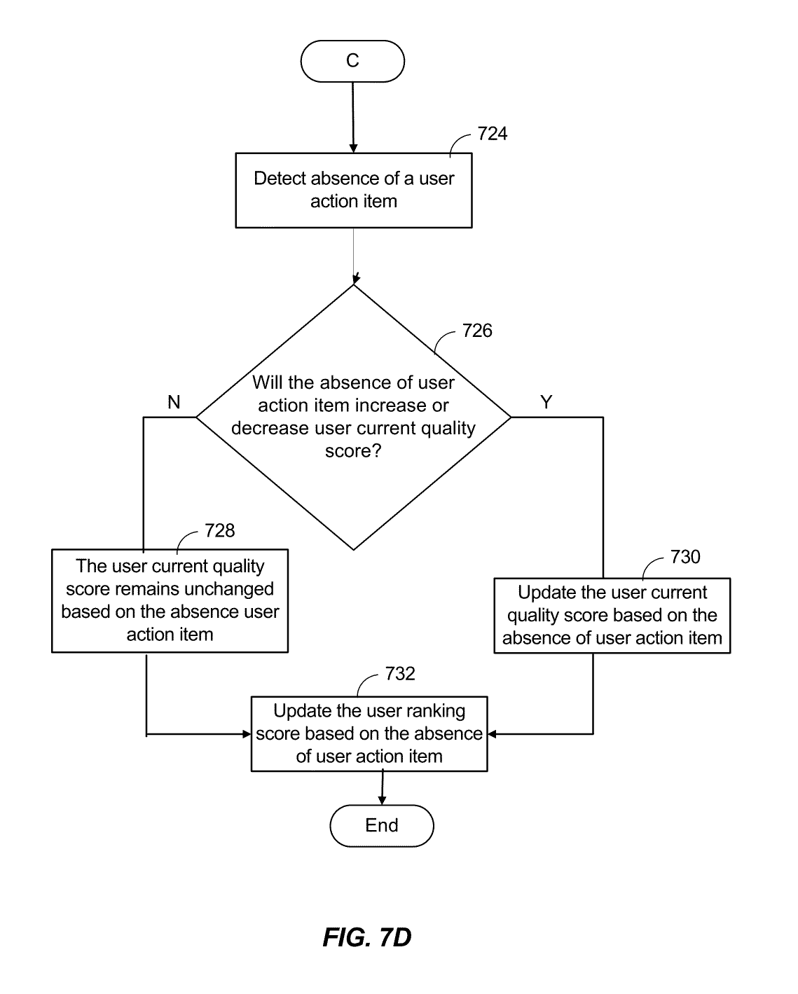

FIG. 7A is a flowchart for an exemplary method for adjusting user ranking score in accordance with one embodiment. The method shown in FIG. 7A may be implemented in the ranking module 590 in communication with the client device 510 as shown in FIG. 6.

At decision block 702, the ranking module determines if an action is completed within the application by a real estate service provider. In one embodiment, the action which is completed within the application by a real estate service provider may be updating account information, such as information contained in the user profile, such as adding an image, removing an image, updating status information, updating contact information, etc. In another embodiment, the action which may be completed within the application by a real estate service provider may be a posting action item by means of the posting module 580a information which is exchanged with the communication service 502, such as, adding video, image, text, zip codes, event information, and geo-location information. In another embodiment, the action which may be completed within the application by a real estate service provider may be responding to or initiating chatting requests with another user by means of the chatting module 570a. In yet another embodiment, the action which may be completed within the application by a real estate service provider may be responding to or initiating comments within the newsfeed module 620a. After determining that an action is completed within the application by a real estate service provider, and then the process continues to block 704, otherwise, the process continues to C.

At block 704, a determination is made as to whether the action completed within the application by a real estate service provider is a posting related action. In one embodiment, the action completed within the application may be evaluated in terms of where the action initiated, in which module, account module, search module, posting module, chat module, or newsfeed module. If the action is determined to be initiated from the posting module 580a, then the process continues to A to be described in FIG. 7B. If the action is determined to be initiated from a module other than the posting module 580a, then the process continues to B to be described in FIG. 7C.

FIG. 7B is a flowchart for an exemplary method of updating a user post score in accordance with one embodiment. The method shown in FIG. 7B may be implemented in the posting module 580a in communication with the communication server 504 posting module 580b.

At start point A, an posting action has been completed within the application by a real estate service provider as described in reference to FIG. 7A.

At block 706, the posting score analysis module 591 will receive a posting item. In one embodiment, the received posting item may include tagged media (such as, image(s), audio file(s), video files(s), etc.), tagged neighborhoods and/or textual based content. After the posting score analysis module 591 receives a posting item, then the process proceeds to block 708.

At block 708, the posting score analysis module 591 will identify the tagged neighborhoods. In one embodiment, the tagged neighborhoods may include zip codes, city names, nicknames of neighborhoods, counties, or other means to describe a geographic area of interest. After the posting score analysis module 591 identifies the tagged neighborhoods, then the process proceeds to block 710.

At block 710, the posting score analysis module 591 will request user's current post score for each of the tagged neighborhoods. In one embodiment, the user may be associated to multiple neighborhoods, wherein the user profile for the user may contain multiple active zip codes associated with the user account. In addition, the user is permitted to post to neighborhoods outside his active (pre-selected) zip codes (or neighborhoods). If the user has a history of posting to those identified neighborhoods, then the posting score analysis module 591 will retrieve the user's current post score for each of the tagged neighborhoods within the received post item. If the user does not have a history of posting to an identified neighborhood, then the posting analysis module 591 will assign a neutral post score as the current post score for each identified tagged neighborhood where the user does not have a current post score. After the user post scores for each of the identified tagged neighborhoods are identified by the post score analysis module 591, and then the process continues to block 712.

At block 712, the post score analysis module 591 will recalculate the user's current post score for each of the identified tagged neighborhoods based on the received posting item, wherein the contents of the posting item may be parsed and analyzed by the dictionary, as described in FIG. 6 in order to generate a new current post score for the user for each of the tagged neighborhoods. After the post scores as associated to tagged neighborhoods are updated based on the posting item, then the process proceeds to B to be described in FIG. 7C.

FIG. 7C is a flowchart for an exemplary method of updating a user's quality score in accordance with one embodiment. The method shown in FIG. 7C may be implemented in the ranking module 590.

At start point B, depending on the outcome of the process of FIG. 7A/7B will result in the process continuing to block 714.

At block 714, the quality score analysis module 592 will receive a user action item.

At block 716, the quality score analysis modules will determine if the user action item will increase or decrease user's current quality score. In one embodiment, the contents of the action item will be analyzed by the quality metrics (or sensors) described in FIG. 6. If the received action item increases or decreases the user's current quality score, then the process continues to block 720. Otherwise, if the received posting item does not increase or decrease the user's current post score, then the process continues to block 718.

At block 718, the user current quality score remains unchanged by the action item. In one embodiment, the user's action item might have a neutral affect on the user's quality score whereby it doesn't rise to the level which require a recalculation of quality score. If it is determined that the user's quality score remains unchanged based on the action item, then the process contuse to block 722.

At block 720, the user current quality score is updated based on the received action item. In one embodiment, the user's post might include a contact phone number whereby the user's quality score is recalculated downward due to the content of the received action item. In another embodiment, the user's action might include chatting and tagging a media video whereby the user's quality score is recalculated upward due to the content of the received action item. If it is determined that the user's quality score is updated based on the action item, then the process contuse to block 722.

At block 722, the user's overall ranking score is recalculated based on the received action item. The overall ranking score is based on a weighted calculation of the two variables, the post score and quality score. In one embodiment, if the received action item generates an update post score or quality score, then the overall ranking score is updated as a result. After the overall ranking score is recalculated based on the received action item, then the process ends.

FIG. 7D is a flowchart for an exemplary method of updating a user's quality score in accordance with one embodiment. The method shown in FIG. 7D may be implemented in the ranking module 590.

At start point C, depending on the outcome of the process of FIG. 7A will result in the process continuing to block 724.

At block 724, the ranking module 590 will detect absence of a user action item. In one embodiment, the ranking module 590 will be configured to assign a specific value to an action item if completed within the application. In another embodiment, the ranking modules 590 will be configured to assign a negative value to an action item if absent (or uncompleted) within the application. If the ranking module 590 detects absence of an action item, then the process will continue to block 726.

At decision block 726, the quality score analysis modules will determine if the absence of user action item will increase or decrease user's current quality score. In one embodiment, the contents of the action item will be analyzed by the quality metrics (or sensors) described in FIG. 6. If the received action item increases or decreases the user's current quality score, then the process continues to block 730. Otherwise, if the received posting item does not increase or decrease the user's current post score, then the process continues to block 728.

At block 718, the user current quality score remains unchanged by the absence of action item. In one embodiment, the user's action item might have a neutral affect on the user's quality score whereby it doesn't rise to the level which require a recalculation of quality score. If it is determined that the user's quality score remains unchanged based on the action item, then the process contuse to block 732.

At block 720, the user current quality score is updated based on the absence of a user action item. In one embodiment, the user's absence of posting might result in the user's quality score being recalculated downward due to the absence of the received action item. In another embodiment, the user's absence of action might include avoiding first person which may result in the user's quality score is recalculated upward due to the content of the received action item. If it is determined that the user's quality score is updated based on the absence of an action item, then the process contuse to block 732.

At block 732, the user's overall ranking score is recalculated based on the absence of an action item. The overall ranking score is based on a weighted calculation of the two variables, the post score and quality score. In one embodiment, if the received action item generates an updated quality score, then the overall ranking score is updated as a result. After the overall ranking score is recalculated based on the absence of an action item, then the process ends.

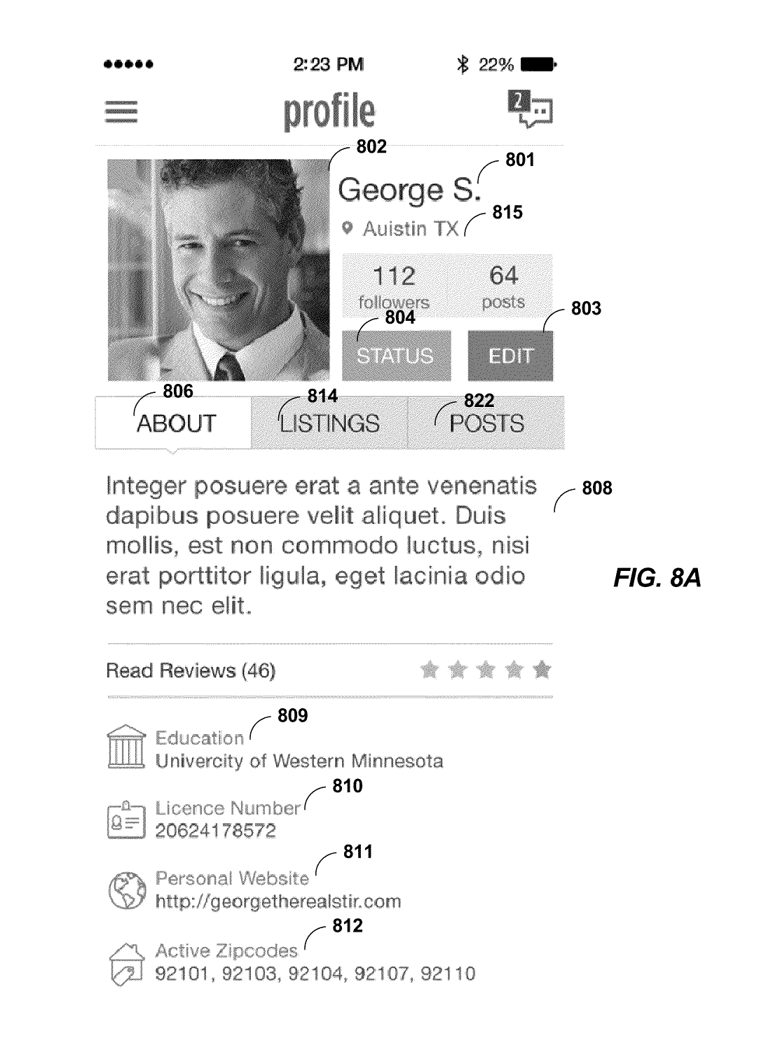

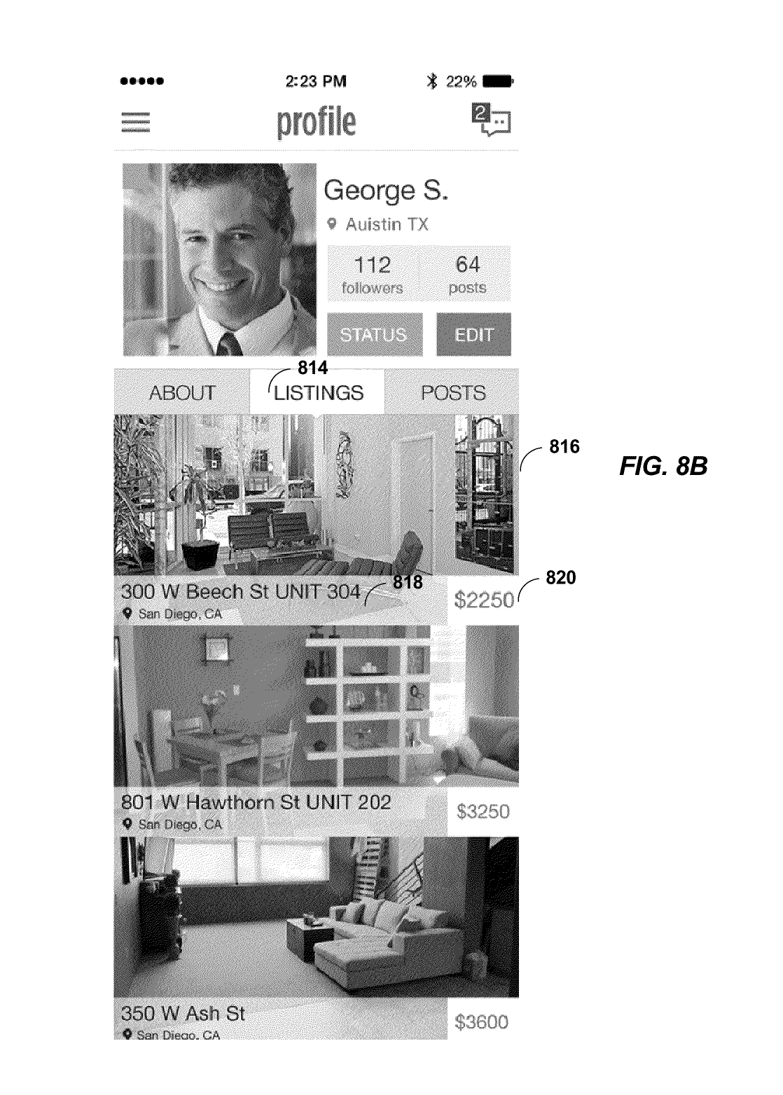

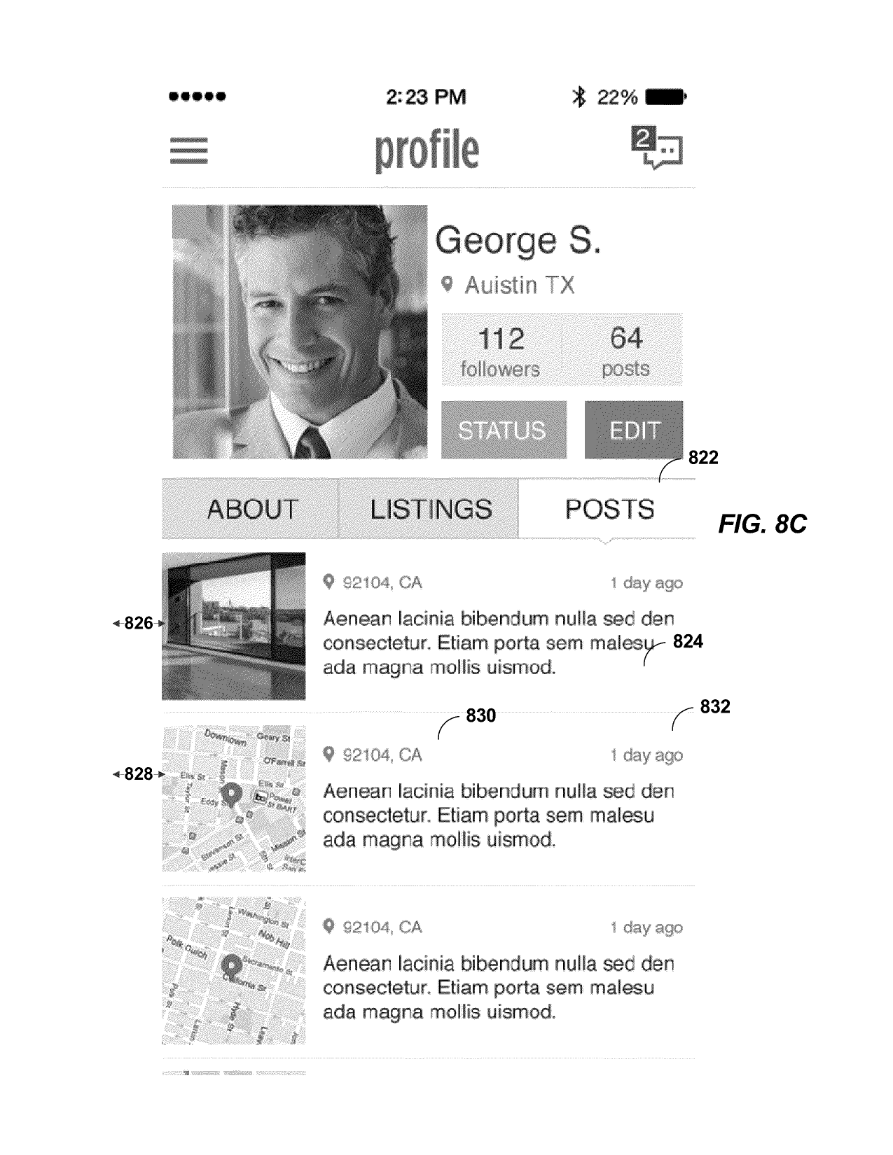

FIG. 8A is an illustrative user profile graphical user interface for the present disclosure. In one embodiment, the user profile graphical user interface may be managed by the account module 585 and allows a user to update his/her account profile by means of a user device 510. In one embodiment, the user profile graphical user interface for a real estate service provider may comprise: a text name entry 801; a image type photo entry 802; edit capabilities (modify profile) 803; availability (available or unavailable) 804; about (personal summary) 806; executive summary 808; education details 809; license number 810; personal web-site 811; active zip codes (geographic areas of expertise) 812; geo-location (or location) 815; followers; posts; listings (active/inactive listings) 814; posts (recent posts/all posts) 822; reviews; rating, and other elements which may describe a real estate service professional. The license number 810 for a real estate service provider may be verified by means of verification request from the communication server 502 to an external third-party server (government licensing agency server) to determine if the information provided by the real estate service provider is consistent with the licensing agency. Moreover, listings (active/inactive listings) 814 may also be verified by validating that the license number provided within the user profile is consistent with the listing agent license number provided by the listing data module 542.

FIG. 8B is an illustrative user profile graphical user interface for the present disclosure. In one embodiment, the user profile may provide tabs for which a user is able to tab to select a specific item to view. In one embodiment, the user profile wherein the “listing” tab 814 is selected provides for: at least one of many images available for a specific listing or rental 816; listing or rental address 818; and listing or rental price 820. In another embodiment, a real estate service provider may be configured to link to active listings managed by the communication server 502 by verifying his provided license number with the listing license number. In yet another embodiment, a real estate service provider is able to create an ad-hoc listing by providing: a property address; a listing or rental price; an image of the property listing for sale or rental.

FIG. 8C is an illustrative user profile graphical user interface for the present disclosure. In one embodiment, the user profile may provide tabs for which a user is able to tab to select a specific item to view. In one embodiment, the user profile wherein the “posts” tab 822 is selected provides for information related to recent posts completed by the user. The posts tab 822 will display post text 824 for which the user published (posted) via the posting module 580a. In addition to post text 824, each user posting may include a geo-location 830 of where the posting physically took place while the user published the post. Also, in addition to the post text 824, each user posting will include a posting date/time element 832, which is displayed within the user profile user interface. If the user uploaded an image in addition to post text 824, then the uploaded post image 826 will be displayed within the user profile user interface. If, optionally, in image was not uploaded when posting a post text 824, then the posting will include geo-location image 828 to display within the user profile user interface. If a user uploaded many images or different content (such as, audio, video, images, etc.) then all this additional content may also be displayed in the user profile posts interface (not shown).

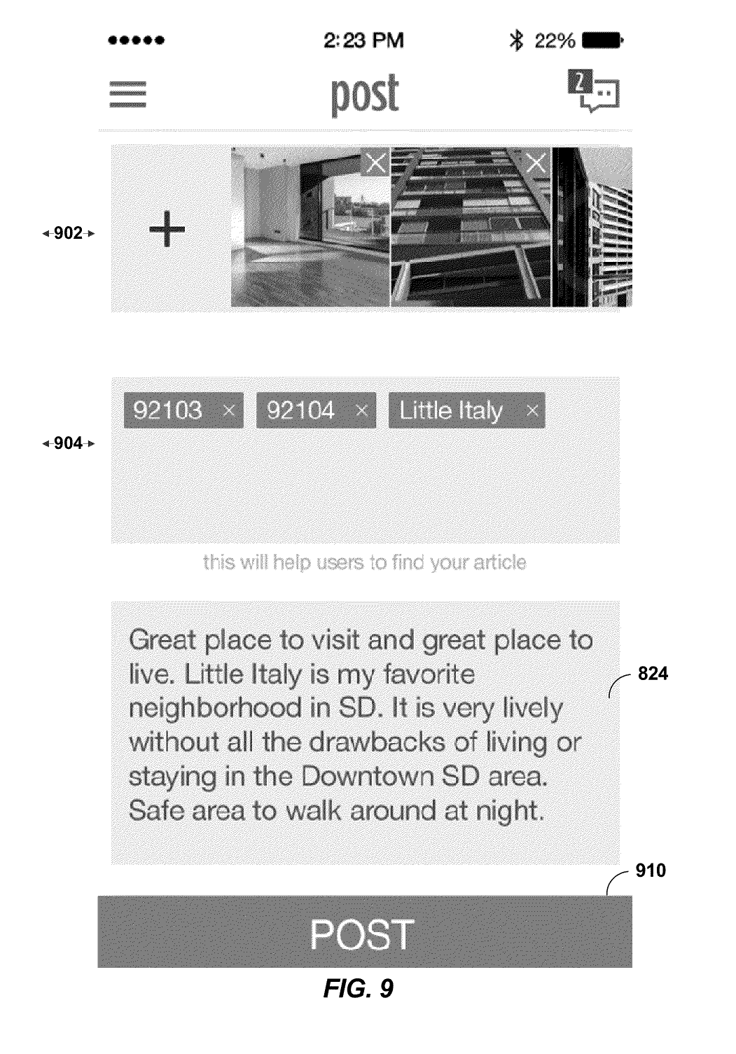

FIG. 9 is an exemplary user interface for the post module for the present disclosure. In one embodiment, a real estate service provider may add content 902, wherein the user selects media file(s) to include (such as, audio, video, photos, etc.). In addition, the user may also include targeted distribution selection 904 of the post by identifying which zip codes, cities or neighborhoods for which the post intended. The targeted distribution selection 904 may be pre-populated with the active zip codes for which the user may have pre-identified in his/her user profile, but the user has the option to remove the pre-populated zip codes and add new target zip codes, cities, or neighborhoods. Also, in addition to adding content 902, and including targeted distribution selection 904, a user may include post text 824 to provide text-based content so share with his followers, community, or global user base. Finally, in order to publish, or transmit the post request from the client device 510 to the communication server 502, the user must select the post submission icon 910. The posting (including: content 902, targeted distribution selection 904, and post text 824) may be publically or privately published to at least one user. The posting (including: content 902, targeted distribution selection 904, and post text 824) created by the user, if publically disclosed, may become associated with the user's profile and may increase or decrease the user's post score, quality score, and/or overall ranking score associated with the user for the specified geographical regions.

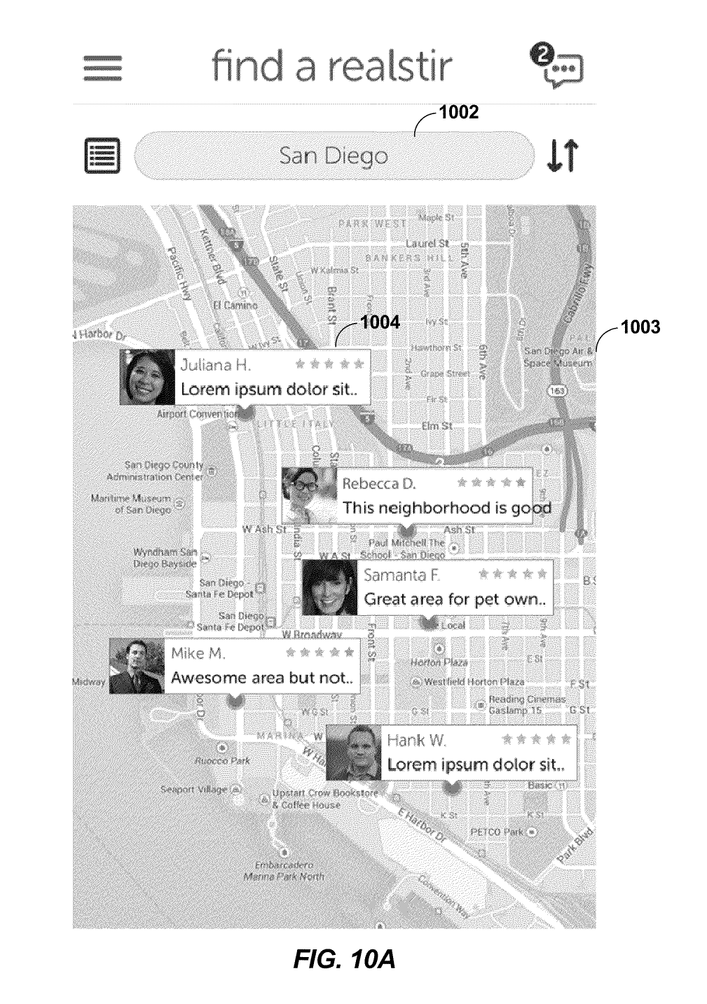

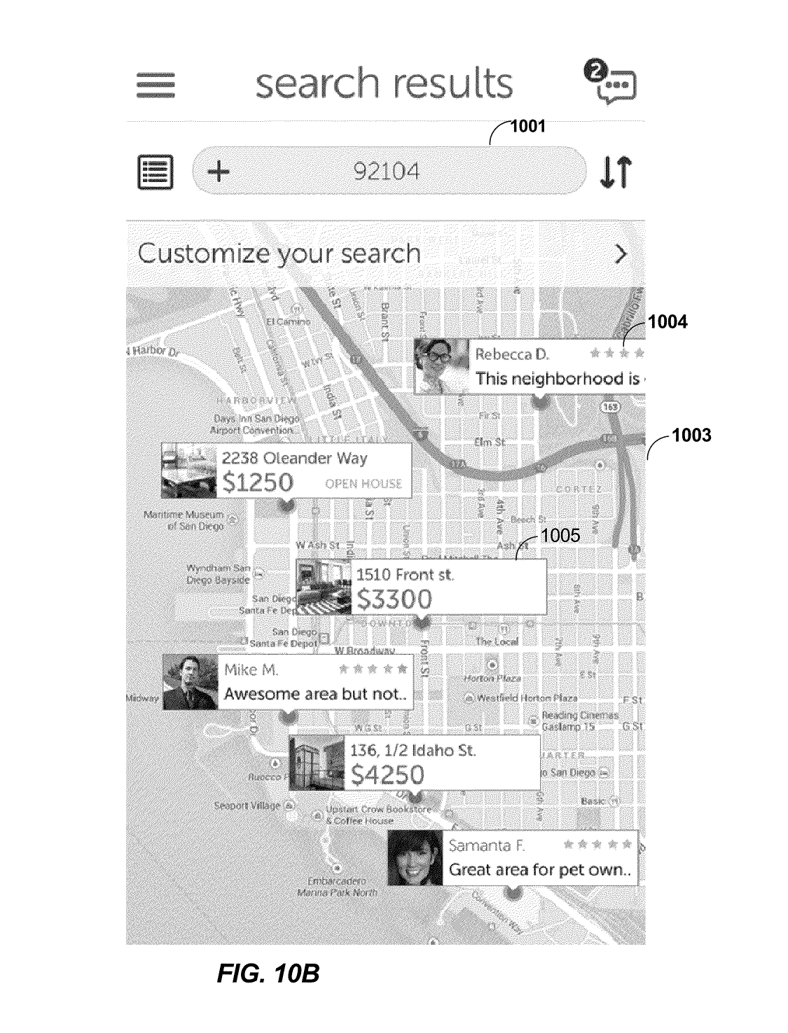

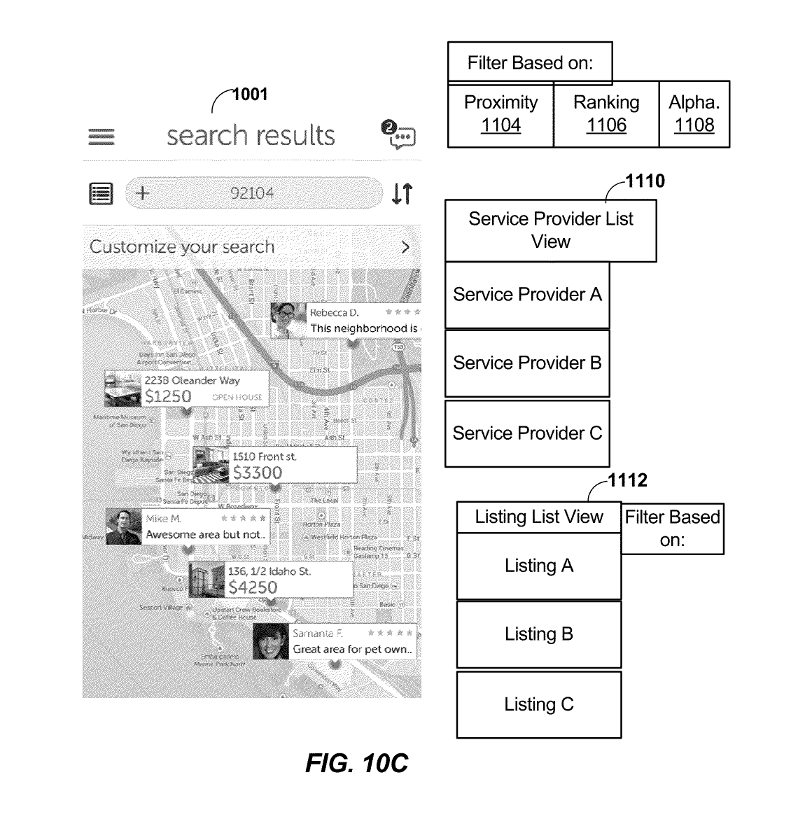

FIG. 10A is an illustrative real estate service provider search and result interface for the present disclosure. In one embodiment, the real estate service provider search interface will require the user to provide a search criteria 1002 in order to generate an interactive map 1003. As a result of service provider search criterial002, the communication server 502 will respond with an interactive map 1003 with service provider icons embedded within the map 1004 which represent the most relevant real estate service providers within the bounds of the geographic region specified in the search criteria 1002. The service provider icons embedded within the map 1004 may include an image, name, ranking score or reviews, last posting text or tagline within a panel to indicate a specific real estate service provider has been identified which meets the user's search criteria. The actual physical location where the service provider icons are embedded within the map 1004 may correspond to the service provider's current geo-location (tracked via mobile global positing systems), last posting location recorded, office location, random location selected by the application within the search criteria geographic region, or latest listing associated with the real estate service professional.

FIG. 10B is an illustrative real estate property search and result interface for the present disclosure. In one embodiment, the user selects to view properties listed for sale, rental, open house, option contract, or trial occupancy within a specific geographical region. In another embodiment, the user selects to view properties listed for sale within a specific geographic region by entering a property search criteria 1001. As a result of the user's input value into the property search criteria 1001, the user is presented with an interactive map 1003 which may include both listing icons embedded within the map 1005 and service provider icons embedded within the map 1004. The service provider icons embedded within the map 1004 are described above in FIG. 10A. In one embodiment, the listing icons embedded within the map 1005 may include a listing address and a listing price. In another embodiment, the listing icons embedded within the map 1005 may include rental address and a rental price. In yet another embodiment, the listing icons embedded within the map 1005 may include trial occupancy address and trial occupancy price. The actual physical location where the listing icons are embedded within the map 1005 may correspond to the physical property address associated with the listing.

FIG. 10C is an illustrative real estate property search and result interface for the present disclosure. In one embodiment, as an alternative or in addition to the interactive map 1003, the search and result interface may provide a list view. In one embodiment, the service provider list view 1110 may provide the ability to filter service providers based upon proximity 1004 to the property search criteria 1001 or service provider search criteria 1002. In another embodiment, the service provider list view 1110 may provide the ability to filter service providers based upon the ranking (or relevancy) 1006 to the property search criteria 1001 or service provider search criteria 1002. In yet another embodiment, the service provider list view 1110 may provide the ability to filter service providers based upon alphabetical 1108 order in accordance to the property search criteria 1001 or service provider search criteria 1002. Moreover, the listings embedded within the interactive map 1003 may also be displayed within a listing list view 1112. In one embodiment, a listing list view 1112 may provide the ability to filter listings based upon newest properties in accordance to the property search criteria 1001. In another embodiment, a listing list view 112 ma provide the ability to filter listings based upon the cheapest properties in accordance to the property search criteria 1001.

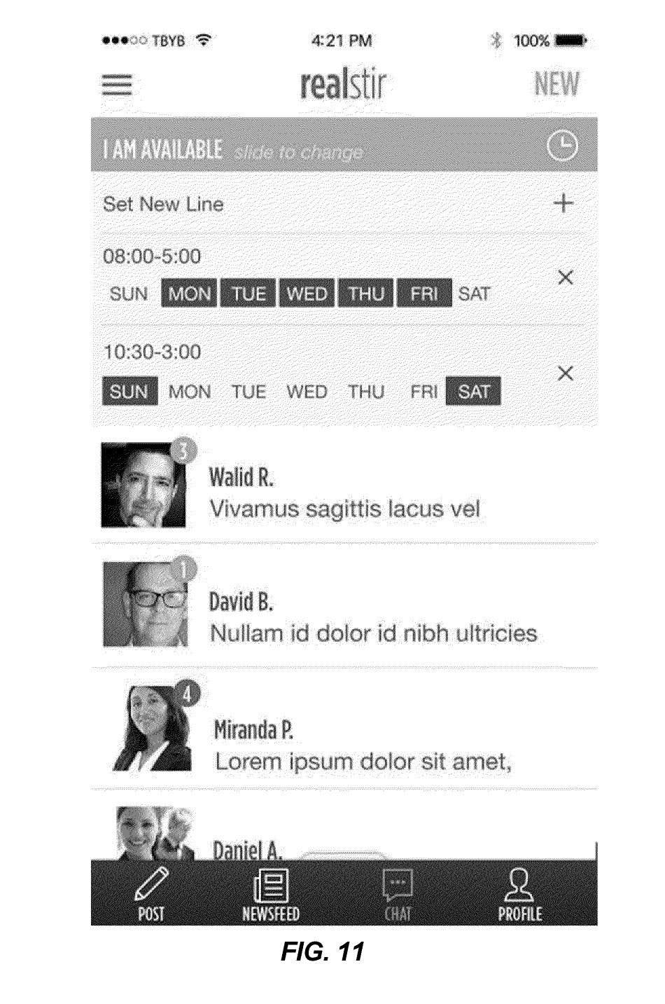

FIG. 11 is an exemplary user interface for the chat module for the present disclosure. The chat module may be configured to permit consumers to contact real estate service providers in real-time and allow real estate service providers to respond to consumers or chat with other real estate service providers in regards to a listing, market conditions, or any other inquiry. In one embodiment, the chat module may provide the user with notification when an outstanding chat request has been received and is awaiting response. Moreover, the notification icon displayed to the user when an outstanding chat request has been received may be color coded to display the availability status of the requesting user. In another embodiment, the chat module will permit a user to respond to a chat request by means of transmitting images, video, audio, or text based content. In another embodiment, a real estate service provider may only be permitted to respond to chat requests and unable to initiate chat requests with other users, or may be limited to initiated chat requests with only other real estate listing users. In one embodiment, a real estate service provider may respond to a consumer's chat request to gather more detailed information regarding a listing listed for sale.

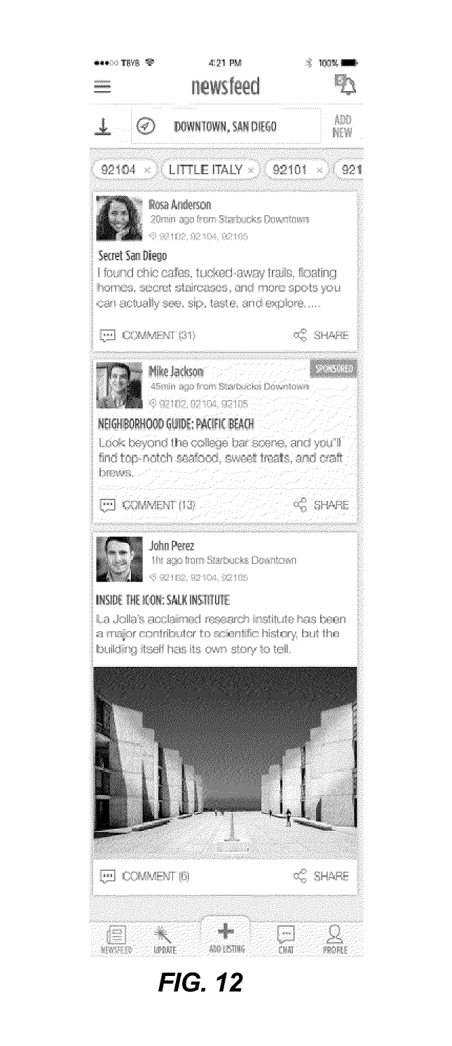

FIG. 12 is an exemplary user interface for the newsfeed module for the present disclosure. In one embodiment, the newsfeed module may provide the user with relevant postings, from other users using the client device posting module 620a, for a specific zip code or neighborhood, or city for which the user may be interested in buying/leasing/or temporary occupying a property. In another embodiment, the newsfeed module may be configured based upon the user's profile preference, and will provide real-time aggregation of posts and advertisements that are of relevance to the user. The newsfeed module 620b may be configured to aggregate postings from the posting module 580b, an advertisement module (not shown), or other modules within the communication server 502 in order to generate a consumer newsfeed displayed to consumers within a client device 510 newsfeed module 620a.

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different data access technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations. The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a device can obtain the various methods upon coupling or providing the storage means to the device. Moreover, any other suitable technique for providing the methods and techniques described herein to a device can be utilized.

The interfaces shown represent example implementations of a tangible device configured to perform one or more of the features described. The interface elements may be implemented via the execution of machine readable instructions to generate a graphical representation of the interface on a device. The graphical representation may be, for example, a machine readable mark-up language (e.g., HTML), executable machine readable instructions (e.g., JavaScript), or combinations of these or other display technologies. In some implementations, the interface may be constructed of physical components such as buttons, circuits, lights, and the like. The interface components may be controlled by a circuit configured to implement the methods described above. In some implementations, it may be desirable to control the interface components via a processor configured to execute stored instructions which cause the interface components to perform aspects of the methods described.

As used herein, the terms “display” or “displaying” encompass a variety of actions. For example, “displaying” may include presenting in audio form, visual form, or some other form that can be made known to the senses. The term may also include a combination of two or more of the foregoing.

As used herein, the terms “determine” or “determining” encompass a variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A computer-implemented method of presenting real estate service providers within an interactive map, comprising:
under control of one or more computing devices configured with specific computer-executable instructions for:
receiving a search request from a client computer application, the search request identifying at least one real estate listing criteria; and
geographic area of interest;
retrieving a plurality of listings based upon the at least one listing criteria and the geographic area of interest;
retrieving a subset of a plurality of real estate service providers based upon the geographic area of interest and overall ranking score,
wherein the overall ranking score is based upon a quality score and a post score for each of the plurality of real estate service providers within the geographic area of interest;
transmitting the plurality of listings and the subset of the plurality of real estate service providers within the geographic area of interest onto the interactive map to the client computer application.

2. A computer-implemented method of presenting real estate service providers within an interactive map of claim 1, wherein the post metric score is based upon a user posting text scored in accordance to a sum of assigned scores for each word or group of words within the posting text, wherein the each word or group of words is associated to a plurality of dictionaries.

3. A computer-implemented method of presenting real estate service providers within an interactive map of claim 1, wherein the quality metrics score is based upon at least one quality metrics determined upon accumulation of a plurality of pre-determined sub-scores associated to a plurality of user functional application usage actions for each of the at least one quality metrics.

4. A computer-implemented method of presenting real estate service providers within an interactive map of claim 1, wherein the real estate service providers are real estate agents.

5. A computer-implemented method of presenting real estate service providers within an interactive map of claim 1, further comprising retrieving a plurality of map data based upon the geographic area of interest.

6. A computer-implemented method of presenting real estate service providers within an interactive map of claim 1, wherein the search criteria is a zip code.

7. A computer-implemented method of presenting real estate service providers within an interactive map of claim 1, wherein the search request includes geographic criteria and property criteria.

8. A computer-implemented method of presenting real estate service providers within an interactive map of claim 1, wherein the plurality of listings are active real estate listings managed by real estate brokers and agents.

9. A computer-implemented method of presenting real estate service providers within a map of claim 1, wherein the overall ranking score for each of the real estate service providers is a summation of a weighted value of each real estate service provider post score for the geographic area of interest and a weighted value of each real estate service provider quality score.

10. A communication server in communication with a datastore, comprising:
a hardware implemented account module configured to permit a user to globally:
update a user profile;
link at least one posting items to the user profile; and
link at least one listing item to the user profile;
a hardware implemented posting module configured to permit a user to globally share the at least one posting item, at least one posting item comprising:
at least one geographic region of interest; and
at least one textual string item to be associated to the at least one geographic region of interest;
a hardware implemented search module configured to
transmit a user search criteria to the communication server;
aggregate data from the communication server in order to generate an interactive map, comprising:
at least one listing;
at least one real estate service provider; and
at least one ranking data for the at the at least one real estate service provider;
a hardware implemented ranking module configured to generate a ranking score for the user based upon a post score and a quality score;
a post score analysis module configured to parse content of a posting item and assign the posting item a numeric value based upon the at least one dictionary used to evaluate the posting item;
a quality score analysis module configured to analyze user behavior by assigning a quality score numeric value to a plurality of actions that a user may undertake and aggregating the quality score numeric value for each user to generate a user quality score.

11. The communication server of claim 10, further comprising a hardware implemented chat module configured to allow user to initiate and respond to chat requests initiated from other users.

12. The communication server of claim 10, further comprising a hardware implemented newsfeed module configured to provide a real-time aggregation of posts and advertisements that are of relevance to the user.

13. The communication server of claim 10, wherein the posting item further comprising at least one media content item to be associated to the at least one geographic region of interest.

14. The communication server of claim 10, wherein the user post score and user quality scores may be unequally weighted in order to generate the user ranking score.

15. The communication server of claim 10, wherein the user search criteria comprises at least one property characteristics and at least one geographic characteristics.

16. A computer-implemented method of identifying relevant real estate service providers, comprising:
receiving a search request from a user, the search request comprising:
a geographic region of interest; and
at least one real estate listing criteria;
retrieving a plurality of listings based upon the at least one real estate listing criteria and the geographic region of interest;
retrieving a plurality of real estate service providers who provider services within the geographic region of interest;
sorting the real estate service providers who provide services within the geographic region of interest based a ranking score;
wherein the ranking score is determined based upon:
a posting score determined by measuring user textual posting quality; and
a quality score determined by measuring user application usage;
transmitting for display a subset of the real estate service providers who provide services within the geographic region of interest and have high ranking score.

17. A computer-implemented method of identifying relevant real estate service providers of claim 16, wherein the at least one real estate listing criteria is price.

18. A computer-implemented method of identifying relevant real estate service providers of claim 16, further comprising dynamically revising the quality score of each of the plurality of real estate service providers by adjusting the score corresponding to at least one of a plurality of items within an individual quality metric.

19. A computer-implemented method of identifying relevant real estate service providers of claim 16, wherein the geographic area of interest is a name of a city.

20. A computer-implemented method of identifying relevant real estate service providers of claim 16, further comprising dynamically revising the post score of each of the plurality of real estate service providers based upon modifying the dictionary weight scores.
